(19) United States
(12) Patent Application Publication
(10) Pub. No.: US 2012/0296725 A1
(43) Pub. Date: Nov. 22, 2012

(54) SYSTEM AND METHOD FOR MANAGING TRANSACTIONS WITH A PORTABLE COMPUTING DEVICE

(76) Inventors: Robert L. DESSERT, Canton, GA (US); Robert Canterbury, San Diego, CA (US); Frank T. Young, Atlanta, GA (US); Scott P. Monahan, San Diego, CA (US); Rolando F. De Gracia, San Diego, CA (US)

(21) Appl. No.: 13/177,973

(22) Filed: Jul. 7, 2011

Related U.S. Application Data
(60) Provisional application No. 61/487,196, filed on May 17, 2011.

(51) Int. Cl. G06Q 30/00

(52) U.S. Cl. 705/14.27

(57) ABSTRACT

A method and system include verifying credentials for gaining access to a central mobile payment controller using the portable computing device (“PCD”). The central mobile payment controller may receive a merchant identifier corresponding to a merchant and then it may compare the merchant identifier against loyalty account data stored in a database. The central controller may also receive product scan data and compare the product scan data against one of offer data and coupon data in a database. After these comparisons, any matches of product scan data to offer data or coupon data may be sent to the PCD and an electronic cash register (“ECR”). Similarly, any matches of the merchant identifier to loyalty account data may be transmitted to the PCD and ECR. During or after the purchase transaction, a message may be generated by the central mobile payment controller which lists one or more preferred payment options.

### PRIORITY AND RELATED APPLICATIONS STATEMENT

This patent application claims priority under 35 U.S.C. §119(e) to U.S. Provisional Patent Application Ser. No. 61/487,196 filed on May 17, 2011, entitled, “SYSTEM AND METHOD FOR MANAGING TRANSACTIONS WITH A PORTABLE COMPUTING DEVICE,” the entire contents of which are hereby incorporated by reference.

### DESCRIPTION OF THE RELATED ART

Portable computing devices (PCDs) are becoming necessities for people on personal and professional levels. These devices may include cellular telephones, portable digital assistants (PDAs), portable game consoles, palmtop computers, and other portable electronic devices.

PCDs are often utilized to conduct financial transactions. For example, PCDs may be used to check bank account balances, transfer funds between bank accounts, and for paying bills. While PCDs are useful for these types of transactions, there is a growing need in the art for utilizing PCDs in other types of transactions.

For example, an ordinary consumer may be assigned a loyalty card which corresponds to a first merchant. The consumer may also own a gift card that also corresponds to this first merchant. The consumer may also be assigned a credit or debit card affiliated with the first merchant which provides the consumer with additional benefits should the credit card be used to make purchases with a first merchant. Further, the first merchant may also accept coupons for products that are sold by the merchant and that may be collected by the consumer.

When the consumer decides to purchase products from the first merchant, the consumer will usually want all the benefits and discounts that are available to the consumer for any given transaction. The problem of the consumer bearing all the responsibility to track these benefits and discounts may grow exponentially when the consumer has similar loyalty cards, credit cards, and coupons for a plurality of other second merchants.

The scenario reaches its apex of complexity when the consumer is standing in a checkout line and in front of a point-of-sale terminal owned by the first merchant and ready to make a purchase of one or more products. The consumer will need to provide the first merchant with any relevant loyalty cards and any relevant coupons or rewards in which the consumer is entitled. When the consumer is ready to pay for the products, he or she may need to present any relevant gift cards as well as any relevant credit or debit cards should the gift cards not cover the total amount due for the purchase of the products.

Accordingly, what is needed is a system and method that may overcome the problems associated with tracking a plurality of benefits and payment methods which are available to a consumer for purchasing goods or services (or both).

### SUMMARY OF THE DISCLOSURE

A method and system create a communications channel whereby a consumer, via a portable computing device (“PCD”) is able to bi-directionally pass and retrieve message data in any of at least four types during a payment transaction: (1) identification (loyalty, reward, membership, etc.); (2) promotion (offer, discount, advertisement, coupon, CPG, etc.); (3) line item (actual product SKU or identification, quantity, rebate certificate, etc.); and (4) payment (credit, debit, stored value, private label, certificate, alternative payment, delayed payment, points redemption, virtual currency, or any other means the particular merchant has agreed to accept as payment).

The method and system include verifying credentials for gaining access to a central mobile payment controller with the portable computing device. The central mobile payment controller may receive a merchant identifier corresponding to a merchant and then it may compare the merchant identifier against loyalty account data stored in a database. The central controller may also receive product scan data and compare the product scan data against one of offer data and coupon data in a database. After these comparisons, any matches of product scan data to offer data or coupon data may be sent to the PCD and an electronic cash register (“ECR”). Similarly, any matches of the merchant identifier to loyalty account data may be transmitted to the PCD and ECR. During or after the purchase transaction, a message may be generated by the central mobile payment controller which lists one or more preferred payment options that may be selected with the PCD to complete a purchase.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a diagram of a wireless portable computing device (PCD) coupled to a wireless communications network which are integral parts of a system for managing transactions with the portable computing device;

FIG. 2A is a diagram of a screen for entering a user's log-in credentials on the PCD to access the system;

FIG. 2B is a diagram of a screen for entering additional log-in credentials such as a password on the PCD to access the system;

FIG. 2C is a diagram of a screen for the PCD confirming access to system;

FIG. 2D is a diagram of a screen that shows the contents of an image being scanned with a camera of the PCD;

FIG. 2E is a diagram of a screen that shows merchant information relevant to a transaction and a line item listing of products being scanned by a product scanner coupled to an electronic cash register;

FIG. 2F is a diagram of a screen that shows merchant information relevant to a transaction and a coupon option that may be selected by a user;

FIG. 2G is a diagram of a screen that shows merchant information relevant to a transaction and a total bill for a purchase along with a plurality of payment options that may be selected by a user;

FIG. 2H is a diagram of a screen that shows an electronic receipt that may be provided upon completion of a transaction with a merchant;

FIG. 2I is a diagram of an exemplary machine-readable tag that may be coupled to an electronic cash register of a merchant;

FIG. 3A is a diagram of hardware components and software components running on a portable computing device for supporting transactions with the portable computing device;

FIG. 3B is a diagram of several software components for a payment application running on a portable computing device;

FIG. 4 is a diagram illustrating details for the merchant point-of-sale system and the merchant enterprise system of FIG. 1 for completing a sales transaction;

FIG. 5 is a diagram illustrating details of a merchant acquirer and credit card subsystems of FIG. 1 for completing a sales transaction;

FIG. 6 is a diagram illustrating details of a gateway and alternative payment systems illustrated in FIG. 1;

FIG. 7A is diagram illustrating details for the central mobile payment controller illustrated in FIG. 1;

FIG. 7B is a diagram illustrating several on-line portals for managing the transaction management system 101 according to one exemplary embodiment of the invention;

FIG. 8 is a functional block diagram illustrating an exemplary portable computing device;

FIGS. 9A-9D are flowcharts illustrating a method for managing transactions with a PCD;

FIG. 10A is a diagram of an exemplary machine-readable tag that may be positioned on a surface such as a table at a restaurant;

FIG. 10B is a diagram of a screen that shows relevant merchant information and an option for an offer from a merchant that may be selected by a user prior to the end of a transaction;

FIG. 10C is a diagram that shows merchant information relevant to a transaction and a total bill for a purchase along with a plurality of payment options that may be selected by user; and

FIG. 10D is a diagram of a screen that shows electronic receipt that may be provided upon completion of a transaction with a merchant, such as a restaurant.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

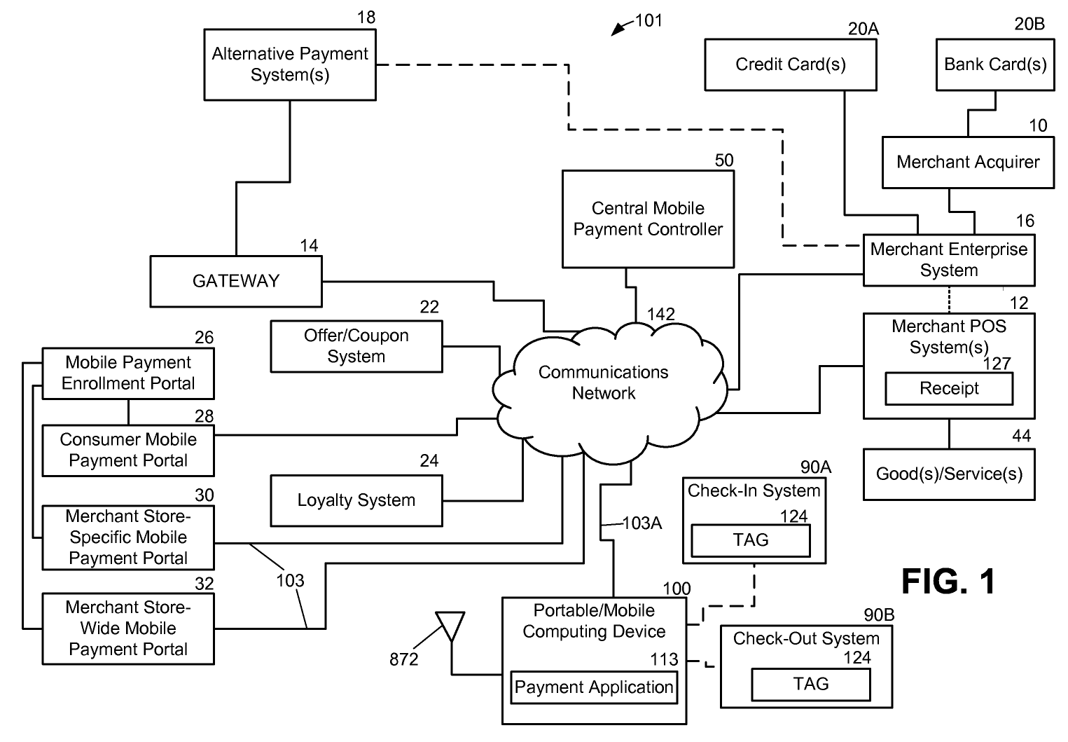

Referring initially to FIG. 1, this figure is a diagram of a wireless portable computing device (PCD) 100 coupled to a communications network 142 via a wireless communication link 103A which are integral parts of a system 101 (also referred to herein as a transaction management system 101) for managing transactions with the portable computing device 100. Many of the system elements illustrated in FIG. 1 are coupled via communication links 103 to the communications network 142.

The communication links 103 illustrated in FIG. 1 may comprise wired or wireless links. Wireless links include, but are not limited to, radio-frequency (“RF”) links, infrared links, acoustic links, and other wireless mediums. The communications network 142 may comprise a wide area network (“WAN”), a local area network (“LAN”), the Internet, a Public Switched Telephony Network (“PSTN”), a paging network, or a combination thereof. The communications network 142 may be established by broadcast RF transceiver towers (not illustrated). However, one of ordinary skill in the art recognizes that other types of communication devices besides broadcast RF transceiver towers are included within the scope of this disclosure for establishing the communications network 142.

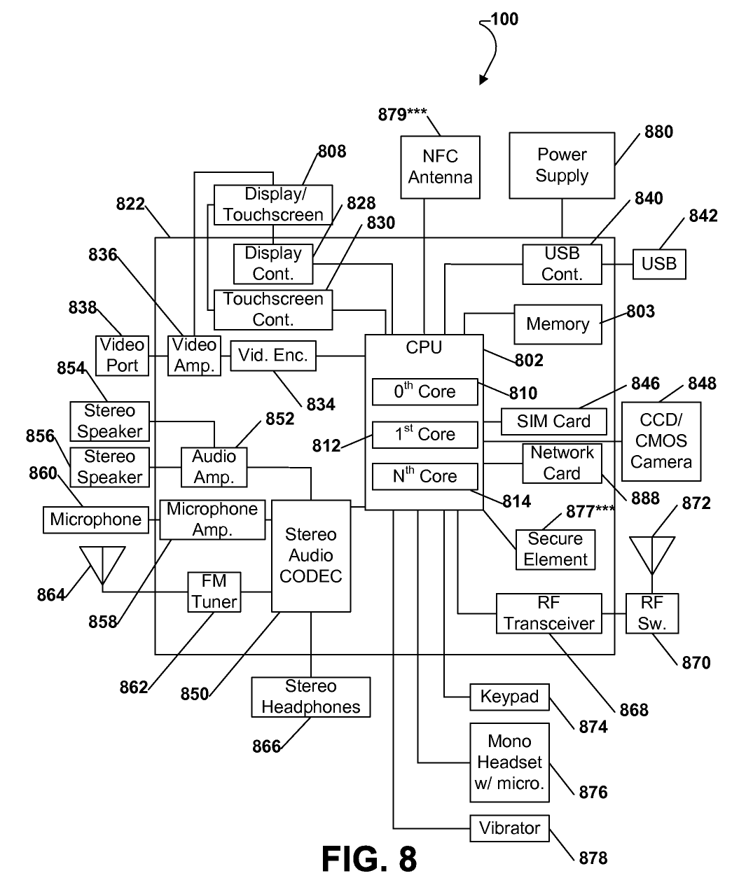

The PCD 100 is shown to have a RF antenna 872 (see FIG. 8) so that a respective PCD 100 may establish a wireless communication link 103A with the communications network 142 via RF transceiver towers (not illustrated). The portable computing device (PCD) 100 may support a payment application 113 that may reside in memory 803 (See FIG. 8) of the PCD 100.

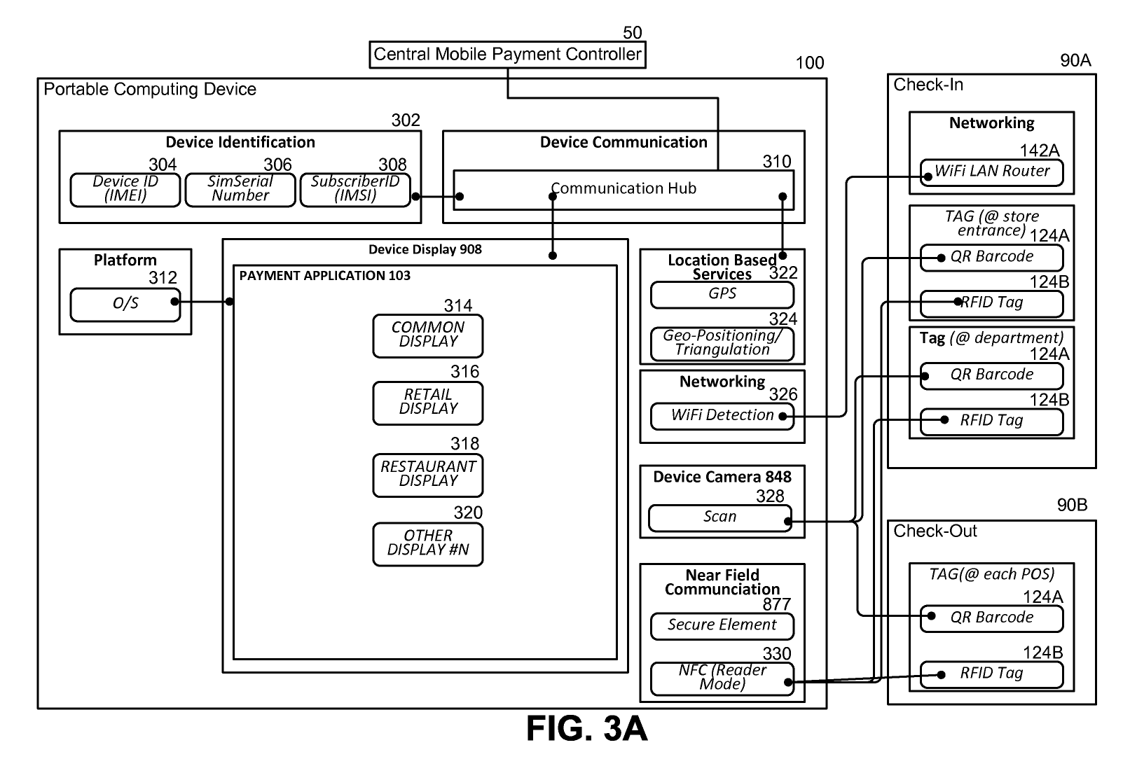

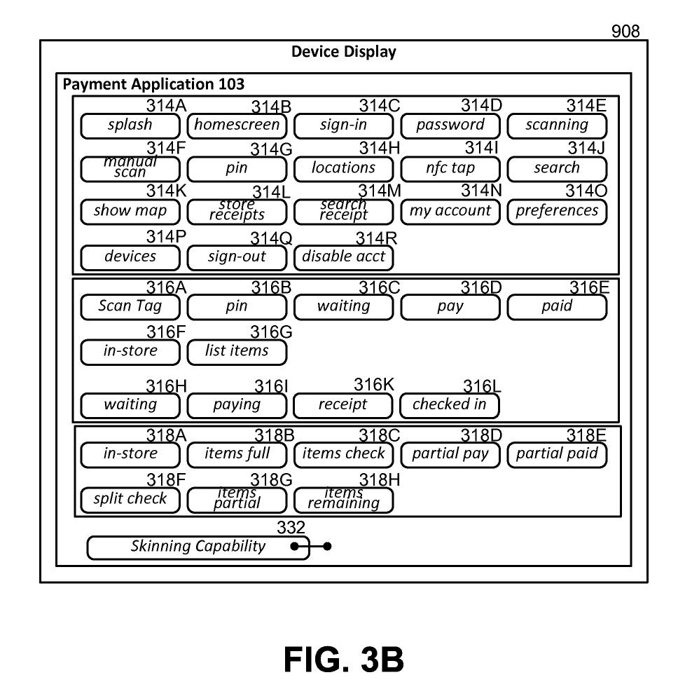

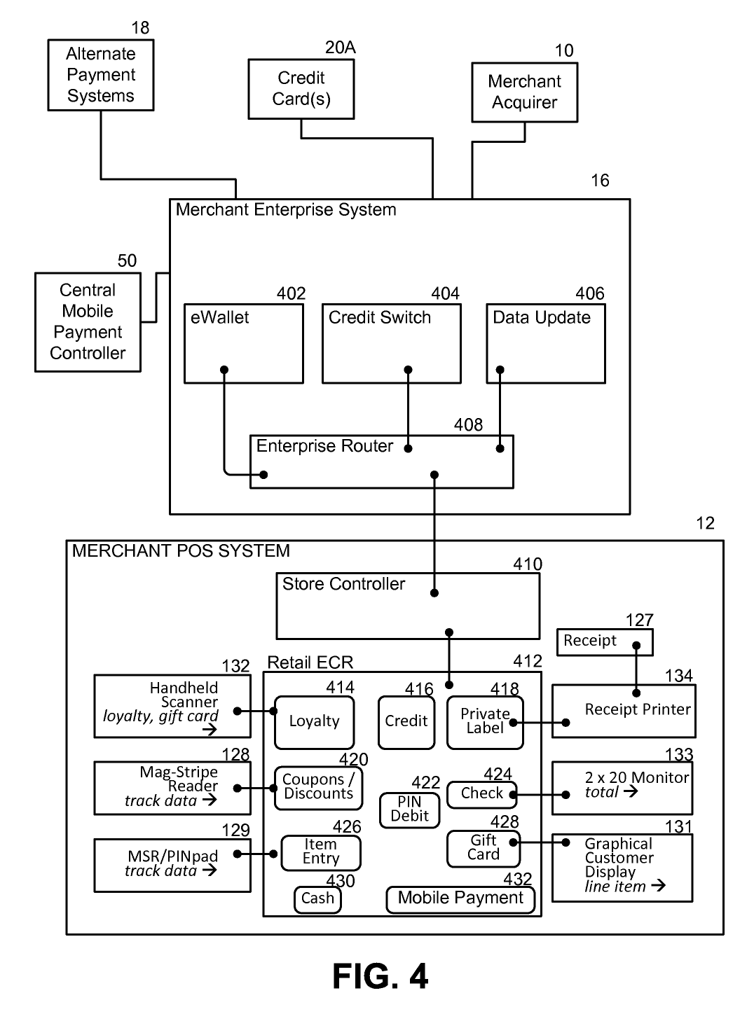

The payment application 113 may allow the PCD 100 communicate with the central mobile payment controller 50 over the communications network 142. The payment application 113 may also allow the PCD 100 to collect information from a machine-readable tag 124 (also referred to herein as tag 124) that may be coupled to an electronic cash register (“ECR”) 412 (not illustrated in FIG. 1, but see FIG. 4) of a check-out system 90B or at some location within the premise of a merchant that comprises a check-in system 90A. Further details about the check-in system 90A and the check-out system 90B will be described below in connection with FIG. 3A.

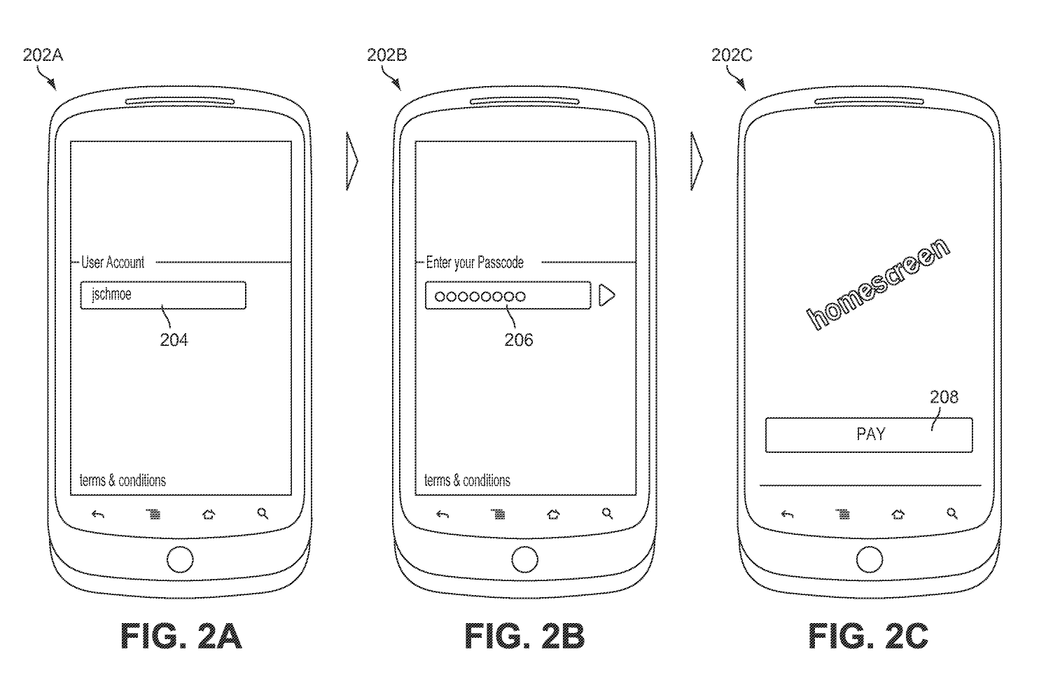

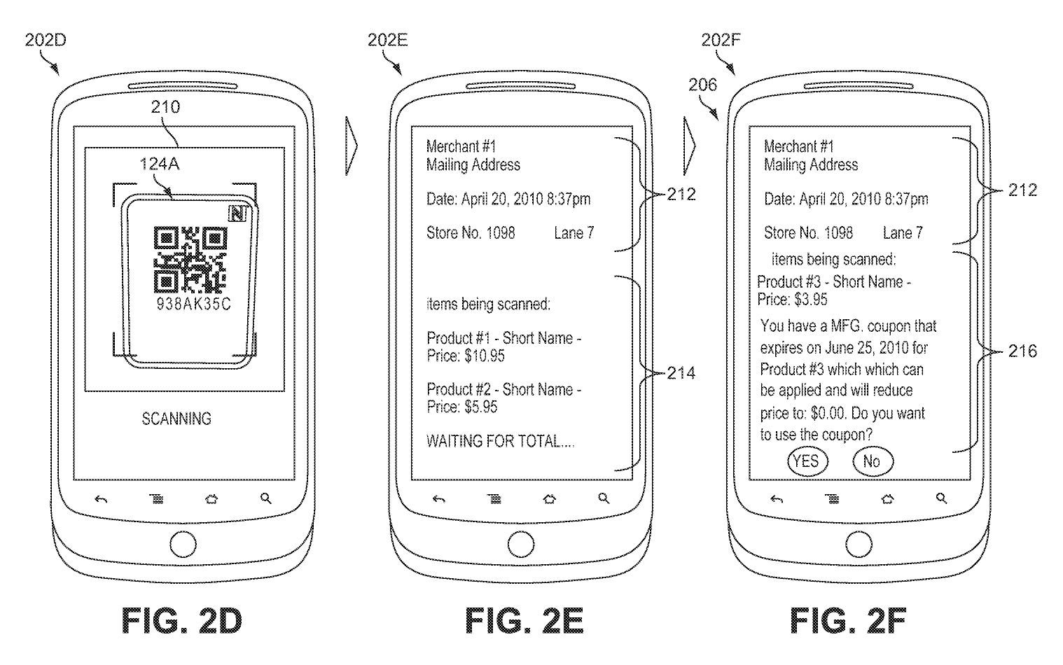

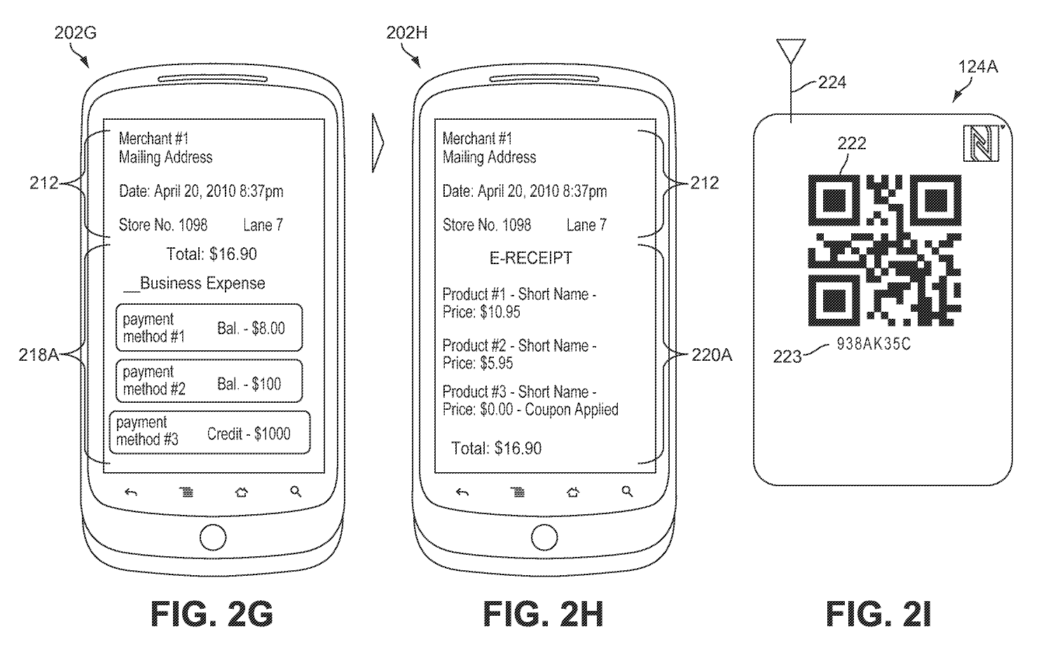

The machine-readable tag 124 may comprise a unique merchant identifier and a unique terminal (or electronic cash register) identifier that helps the PCD 100 to manage point-of-sale (POS) transactions. Further details about the machine-readable tag 124 will be described below in connection with FIG. 2I. The ECR 412 (not illustrated in FIG. 1, but see FIG. 4) of the Merchant POS system 12 may comprise a mechanical or electronic device or combination thereof for calculating and recording sales transactions. The ECR 412 of the merchant POS system 12 may produce a physical receipt 127 at the end of a transaction that lists goods and/or services purchased with the portable computing device 100. Further details about the merchant POS system 12 will be described below in connection with FIG. 4.

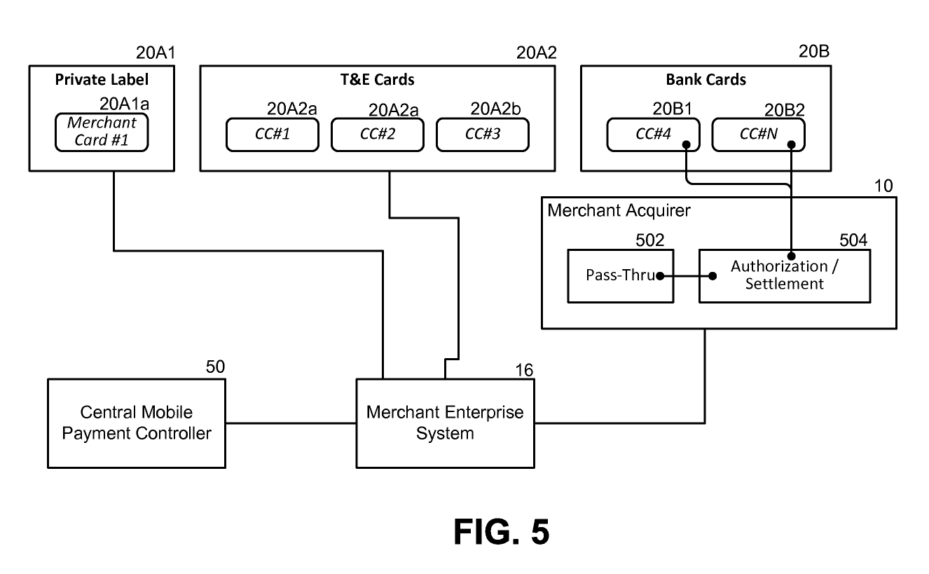

The merchant POS system 12 may be coupled to the merchant enterprise system 16 via the communications network 142. The merchant enterprise system 16 may support the completion of transactions when credit cards or when bank cards have been selected as a form of payment for a particular transaction. Further details about the merchant enterprise system 16 will be described below in connection with FIG. 4. The merchant enterprise system 16 may be coupled to a merchant acquirer 10 and one or more credit card systems 20A. The merchant acquirer 10 may be coupled to one or more bank card systems 20B supported by financial institutions like banks. Further details about the merchant acquirer 10, the credit card systems 20A, and bank card systems 20B will be described below in connection with FIG. 5.

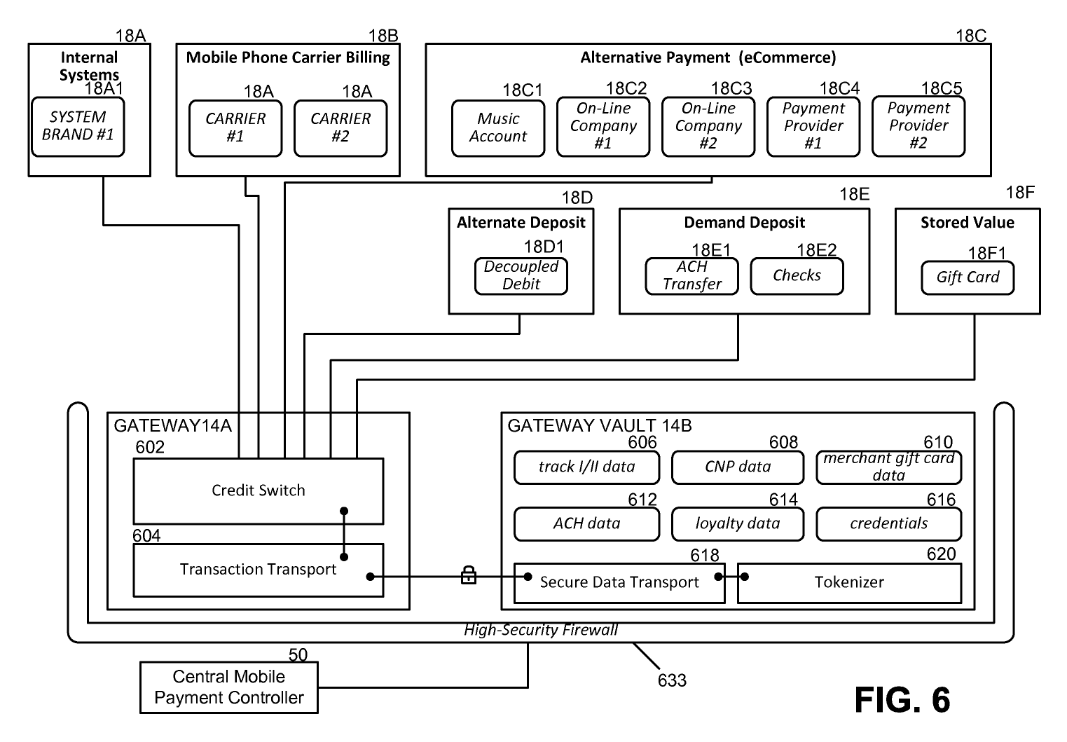

The merchant enterprise system 16 may also be coupled to alternative payment systems 18. Alternative payment systems 18 may include, but are not limited to, such systems like PayPal™, Google payments, etc. that currently exist as of this writing. The alternative payment systems 18 may be coupled to a gateway 14. Further details about the alternative payment systems 18 and gateway 14 will be described below in connection with FIG. 6.

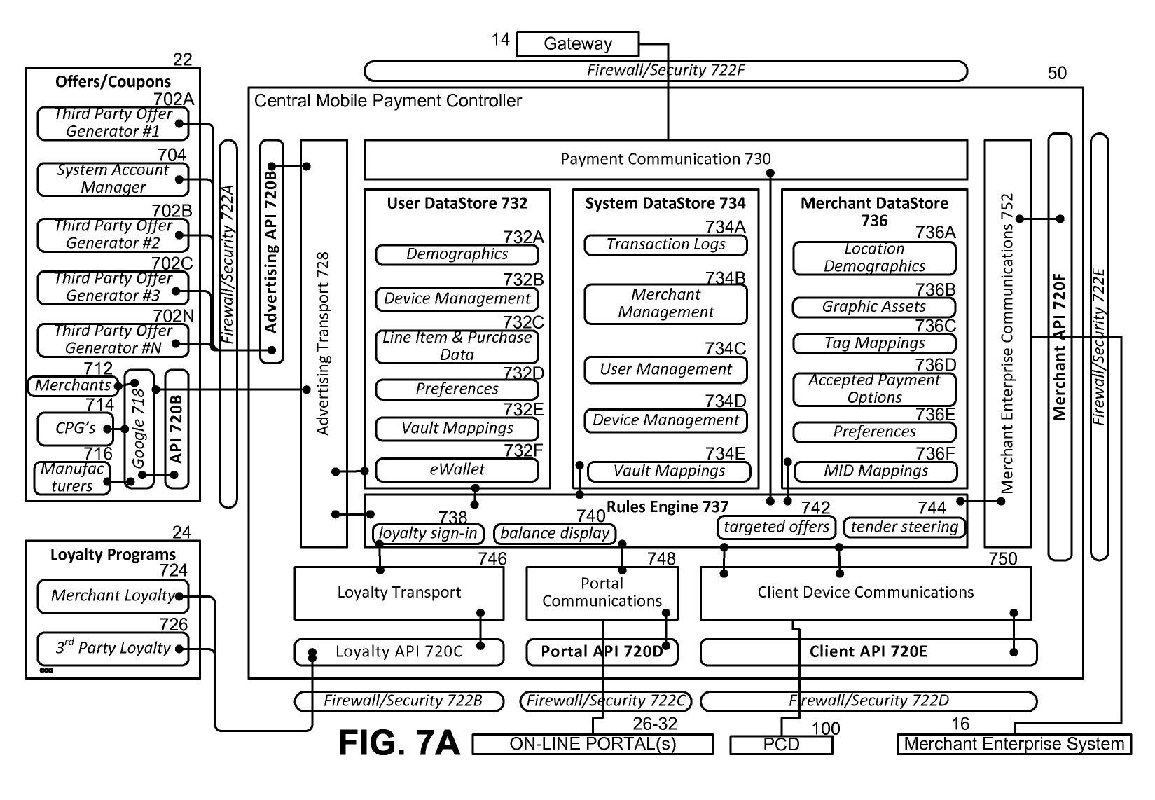

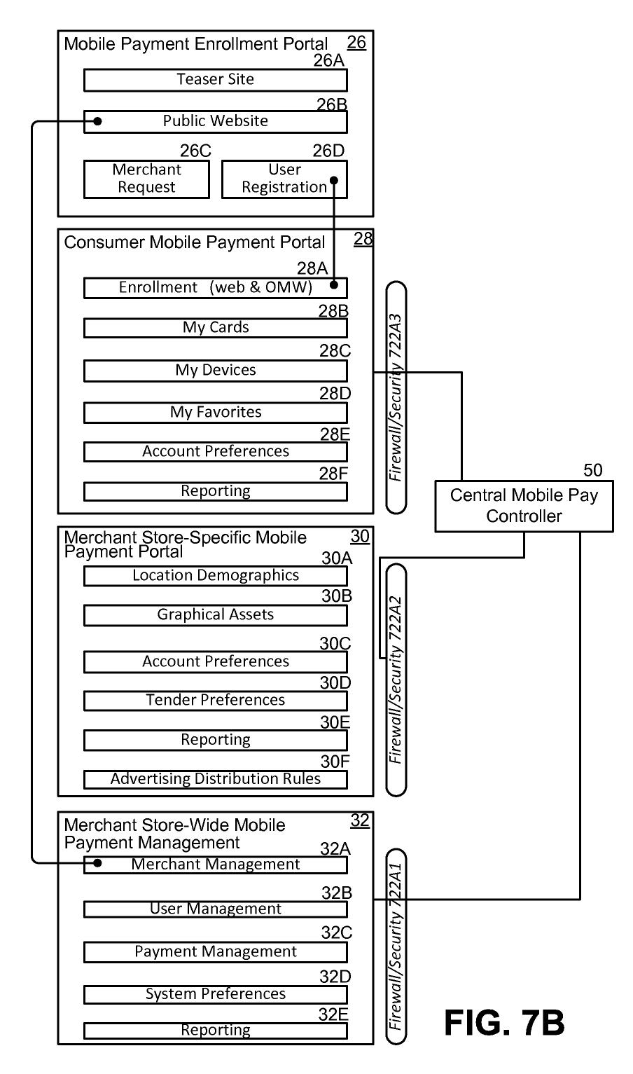

A central mobile payment controller 50 is coupled to the portable computing device 100 via the communications network 142. The central mobile payment controller 12 is responsible for connecting or linking the portable computing device 100 to the merchant POS system 12 and merchant enterprise system 16. The central mobile payment controller 12 is also responsible for coupling the offer/coupon system 22 and loyalty system 24 to the portable computing device 100. The central mobile payment controller 12 is also responsible for managing several online portals 26-32. Further details about the central mobile payment controller 12 will be described below in connection with FIG. 7A. Meanwhile, further details about be online portals 26-32 will be described below in connection with FIG. 7B.

An operator of the PCD 100 may desire to purchase one or more products/services 44 that may be scanned with a product scanner 132 (See FIG. 4). Prior to or in parallel to the operation of scanning products with the product scanner 132, the operator of the PCD 100 may retrieve the unique terminal identifier and the merchant identifier associated with the tag 124 which is affixed to the ECR 412 of the Merchant POS system 12. The operator of the PCD 100 may retrieve the data from the tag 124 by scanning the tag 124 with the camera 848 or with a near-field-communication (“NFC”) antenna 879.

This unique terminal (or ECR) identifier and merchant identifier retrieved by the PCD 100 may be relayed back to the central mobile payment controller 50 along with a personal identification number (“PIN”). In response to receiving the terminal identifier, merchant identifier, and PIN, the central mobile payment controller 50 may send messages to merchant enterprise system 16. The central mobile payment controller 50 may request the merchant enterprise system 16 for the product scan data being generated by the product scanner 132 of the merchant POS system 12.

In response to this request from the central mobile payment controller 50, merchant enterprise system 16 may forward the product scan data to the central mobile payment controller 50. The central mobile payment controller 50, in turn, may relay the product scan data to the PCD 100 so that the product scan data may be displayed on the display device of the PCD 100. The PCD 100 may provide an option that may be selected by an operator to turn off this product scan data from being displayed on the display device of the PCD 100 while the products 130A are being scanned.

While the products/services 44 are being scanned by the product scanner 132 of the merchant POS system 12, the central mobile payment controller 50 may also retrieve loyalty account information from a profile associated with an operator of the PCD 100 which is stored in the loyalty system 24. The central mobile payment controller 50 may communicate this loyalty account information to merchant enterprise system 16. The merchant enterprise system 16 may relay this loyalty account information to the merchant POS system 12. The central mobile payment controller 50 may also retrieve unique and personalized offers tailored to the operator of the PCD 100 from the offer/coupon system 22.

Meanwhile, when the product scanner 132 of the merchant POS system 12 is finished scanning the products/services 44 for purchase, the ECR 412 may generate a final total of money due for payment in connection with the purchase of the products/services 44. This final total data is communicated from the merchant POS system 12 to the merchant enterprise system 16. The merchant enterprise system 16 then relays the final total to the central mobile payment controller 50 which in turn relays this information to the PCD 100. In addition to relaying this final total data to the PCD 100, the central mobile payment controller 50 may also retrieve payment accounts available to the operator and that may have been selected by an operator in a predetermined order for display on the PCD 100.

At this time, or any time during the transaction cycle, an operator of the PCD 100 may select from one of a plurality of payment methods supported by the central mobile payment controller 50. Alternatively, an operator of the PCD 100 may select a plurality of payment methods in order to pay the final total due in connection with the purchased products/services 44. Once a payment method or a combination of methods are selected by an operator of the PCD 100, the PCD 100 relays this selection to the central mobile payment controller 50.

Depending upon the form of payment selected, the central mobile payment controller 50 selects data from a gateway 14 for rendering payment associated with the final total data. If an alternative form of payment is selected by the operator of the PCD 100, then the central mobile payment controller 50 will relay the alternative payment account information through the gateway 14 to the alternative payment systems 18.

If a traditional form of payment is selected by the operator of the PCD 100, such as the selection of a credit card account, then the central mobile payment controller 50 may relay this credit card payment information over a secure channel to the merchant enterprise system 16. The merchant enterprise system 16 may relay the credit card payment information to the merchant acquirer 10 for bank card systems 20B or to credit card networks for credit card systems 20A.

Exemplary credit card networks, may include, but are not limited to, the VISA™ credit card network, the MASTERCARD™ card network, the DISCOVER™ credit card network, the AMERICAN EXPRESS™ credit card network, and other similar charge card proprietary networks. One of ordinary skill in the art recognizes that transactions for merchant gift cards may also follow the same flow with the merchant enterprise system 16 directing the transaction to the merchant's stored value processor that may be part of the credit card systems 20A or alternative payment systems 18.

If payment is approved by one of the traditional payment systems 20, then the merchant enterprise system 16 may relay this approval message to the merchant POS system 12. The merchant POS system 12 relays the approval message to the electronic cash register 126 and to the central mobile payment controller 50. If payment is approved by one of the alternative payment systems 18, the central mobile payment controller 50 may relay this information to the PCD 100 and the merchant enterprise system 16.

The central mobile payment controller 50 may send any payment approval messages to the PCD 100 for display on the display device of the PCD 100. The central mobile payment controller 50 may generate an electronic receipt that can be forwarded and displayed on a display device of the PCD 100. Meanwhile, the ECR 412 may also generate a hard copy receipt 127.

FIG. 2A is a diagram of a screen 202A of the PCD 100 for entering a user's log-in credentials, such as a user name 204 on the PCD 100 to access the system 101. The user's log-in credentials 204 may comprise a unique user name selected by an operator of the PCD 100. When the user name is entered by the operator of the PCD 100, the central mobile payment controller 50 may verify that the user name entered and a unique identifier assigned to the PCD 100 match by checking client profiles which may be stored in the eWallet module 732F (See FIG. 7A). One of ordinary skill in the art recognizes that authentication of the operator of the PCD 100 at this stage may include other security measures beyond just a user name/password. Other security measures which may be used as alternatives or as supplemental security measures to those already described include, but are not limited to, biometrics, secure elements such as integrated-circuit (IC) cards or smart cards, and other like methods in the art of multi-factor authentication.

If the user name and unique identifier assigned to the PCD 100 do not match, then the central mobile payment controller 50 may deny entry to the system 101 and prompt the user for correct credentials for a predetermined number of times. If the user name and unique identifier assigned to the PCD 100 do match, then the central mobile payment controller 50 may prompt the operator of the PCD 100 for a password 206 associated with the user name on the account such as illustrated in FIG. 2B.

FIG. 2B is a diagram of a screen 202B for entering additional log-in credentials such as a password 206 on the PCD 100 to access the system 101. If the correct password 206 is not entered by an operator of the PCD 100 after a predetermined number of times, the central mobile payment controller 50 may lock out the account associated with the user name that was entered in the screen 202A of FIG. 2A. If the correct password 206 is entered by an operator of the PCD 100, then the central mobile payment controller 50 may generate a welcome screen 202C such as illustrated in FIG. 2C.

FIG. 2C is a diagram of a screen 202C for the PCD 100 confirming access to system 101. The welcome screen 202C may also comprise an execution button 208 that may activate the transaction software 501 residing on and supported by the PCD 100. Upon selecting the execution button 208, the PCD 100 may launch the payment application 113 running on the PCD 100 which causes the PCD 100 to generate the next screen 202D as illustrated in FIG. 2D.

FIG. 2D is a diagram of a screen 202D that shows the contents of an image 210 being scanned with a camera 848 of the PCD 100. The image 210 being scanned by the camera 848 (See FIG. 8 for camera) may comprise one of the tags 124 of FIG. 1. As noted previously, the tag 124 of FIG. 1 may comprise machine-readable data such as a two-dimensional barcode that contains a unique identifier associated with a particular electronic cash register 126 and a particular merchant. The 2-D bar code may include, but is not limited to, the following symbologies: Aztec Code, 3-DI, ArrayTag, Small Aztec Code, Chromatic Alphabet, Chromocode, Codablock, Code 1, Code 16K, Code 49, ColorCode, Compact Matrix Code, CP Code, CyberCode, d-touch, DataGlyphs, Datamatrix, Datastrip Code, Dot Code A, EZcode, Grid Matrix Code, High Capacity Color Bar code, HueCode, INTACTA.CODE, InterCode, MaxiCode, mCode, MiniCode, Micro PDF417, MMCC, Nintendo e-Reader#Dot code, Optar, PaperDisk, PDF417, PDMark, QR Code, QuickMark Code, Semacode, SmartCode, Snowflake Code, ShotCode, SuperCode, Trillcode, UltraCode, UnisCode, VeriCode, VSCode, WaterCode, for example.

Instead of a two dimensional bar code, a one dimensional bar code may be employed to provide the unique electronic cash register identifier and the unique identifier associated with the merchant. Exemplary one-dimensional bar codes may include, but are not limited to, U.P.C., Codabar, Code 25—Non-interleaved 2 of 5, Code 25—Interleaved 2 of 5, Code 39, Code 93, Code 128, Code 128A, Code 128B, Code 128C, Code 11, CPC Binary, DUN 14, EAN 2, EAN 5, EAN 8, EAN 13, Facing Identification Mark, GS1-128 (formerly known as UCC/EAN-128), GS1 DataBar formerly Reduced Space Symbology (“RSS”), HIBC (HIBCC Bar Code Standard), ITF-14, Latent image bar code, Pharmacode, Plessey, PLANET, POSTNET, Intelligent Mail Bar code, MSI, PostBar, RM4SCC/KIX, JAN, and Telepen. Other machine readable codes for retrieving the unique identifiers associated with the electronic cash register 126 and merchant are well within the scope of the invention such as contact-less or wireless communication methods such as near-field communications (NFCs) used with smart cards and RF-ID cards as understood by one of ordinary skill in the art. Further, in another exemplary embodiment, the operator of the PCD 100 may key-in a human-readable code 223 associated with the unique identifier of the electronic cash register 126 and the merchant.

As discussed above, once the central mobile payment controller 50 has the unique identifier associated with the electronic cash register 126 and the identifier associated with the merchant from the scanned image 210, then the central mobile payment controller 50 may communicate with the merchant enterprise system 16 for receiving product scan data generated by the product scanner 132.

FIG. 2E is a diagram of a screen 202E that shows merchant information 212 relevant to a transaction and a line item listing 214 of products being scanned by a product scanner 132 coupled to an ECR 412 (See FIG. 4). The merchant information 212 may comprise information such as, but not limited to, a merchant name, a mailing address of the store, date and time data relevant to the transaction, a store number, and a electronic cash register number, and other like information. The line item listing 214 of product scan data may comprise information such as, but not limited to, a product number, a short name for the product, a price and other similar information. According to an exemplary embodiment, an operator of the PCD 100 may shut “off” the line item listing 214 as a user defined preference which may be stored in the second storage device 146B.

While the product scanner 132 (of FIG. 4) is scanning the machine-readable product codes from the products/services 44, the central mobile payment controller 50 may match these machine-readable product codes with coupon data retrieved from the offer/coupon system 22. The offer/coupon system 22 may include one or more client profiles associated with the PCD 100. If the central mobile payment controller 50 determines a match between a coupon retrieved from the offer/coupon system 22 and the products/services 44 being scanned, the central mobile payment controller 50 may prompt the operator of the PCD 100 to take some action, such as illustrated in FIG. 2F as described below.

FIG. 2F is a diagram of a screen 202F that shows merchant information relevant to a transaction and a coupon option 216 that may be selected by an operator of the PCD 100. Screen 202F may be generated in response to the central mobile payment controller 50 determining a match between a coupon retrieved from the offer/coupon system 22 and products/services 44 being scanned. Screen 202F may list merchant information 212 and the coupon option 216 which prompts the operator of the PCD 100 to decide whether or not to use a coupon that matches a product 130 which was scanned by the product scanner 132A. This coupon option 216 may be turned off by an operator of the PCD 100 so that this screen 202F is not generated when a match is found by the central mobile payment controller 50.

An operator of the PCD 100 may allow automatic matching of coupons as they are discovered by the central mobile payment controller 50. In the exemplary screen 202F, the operator of the PCD 100 is asked to decide whether or not to use a manufacturer's coupon that may reduce the price of purchase for a products/services 44 to zero. If the operator of the PCD 100 decides not to use the coupon, then the coupon data may remain in storage accessible by the central mobile payment controller 50 until another match is found by the central mobile payment controller 50.

FIG. 2G is a diagram of a screen 202G that shows merchant information 212 relevant to a transaction and a total bill for a purchase along with a plurality of payment options 218A that may be selected by the operator. In the example illustrated in FIG. 2G, the total amount due for the purchase is $16.90. The payment options 218A allow a user to select the expense as a business expense towards taxes. The payment options 218A also allow an operator of the PCD 100 to select among a plurality of payment methods that may have been previously selected by the operator and stored in a user's profile in the second storage device 146B.

In other words, prior to conducting any transactions, an operator of the PCD 100 may arrange a predetermined listing of the sequence of payment methods which should be displayed to an operator of the PCD 100 whenever the operator employs the PCD 100 for a transaction. The operator of the PCD 100 may also create an association with the predetermined order of payment methods for particular merchants. This means that an operator of a PCD 100 may have a first sequence of payment methods for a first merchant and a second different sequence of payment methods for a second merchant that are stored in a client profile of the central mobile payment controller 50. The central mobile payment controller 50 may also display payment options 218A that provide the operator of the PCD 100 with additional benefits such as credit cards affiliated with a current merchant which may award more loyalty points if the affiliated credit card is used for a purchase.

In other exemplary embodiments, the central mobile payment controller 50 may allow the merchant to control the payment options 218A that are presented to the operator of the PCD 100. In this way, the merchant may be provided with a form of payment steering—an indirect control of how an operator of a PCD 100 may decide on how to pay for a products/services 44.

The operator of the PCD 100 may also select one or more different payment methods to pay the total final amount due for a particular purchase. So, for example, an operator may select a credit card to pay a portion of the final bill along with payment from a stored value card and payment from a debit card. According to one exemplary aspect of the invention, the current balances of stored value accounts as well as remaining credit on credit card accounts may be displayed in conjunction with the payment options 218A that are available for selection by the operator with the PCD 100 as illustrated in FIG. 2G.

According to another exemplary feature of the system 101, credit card issuers as well as debit card issuers and stored value account issuers do not need to send any physical tokens to an operator of the PCD 100 when new account numbers may be assigned to a particular operator of the PCD 100. Instead of mailing physical tokens bearing the new account numbers, the issuers of the new account numbers may update the data a storage device or a secure vault. A corresponding message may be transmitted from the central mobile payment controller 50 to the operator of the PCD 100 when new account numbers have been stored in the secure vault or a storage device in place of old account numbers.

FIG. 2H is a diagram of a screen 202H that shows an electronic receipt 220A that may be provided upon completion of a transaction with a merchant. The electronic receipt 220A may comprise a product listing as well as the total price paid for the products/services 44 which were purchased. The payment method(s) selected by the operator (though not illustrated) may also be displayed on the electronic receipt 220A.

FIG. 2I is a diagram of an exemplary machine-readable tag 124 that may be coupled to an electronic cash register 126 of a merchant that is part of a check-out system 90B. Alternatively or in addition to the check-out system 90B, the machine-readable tag may be provided in a check-in system 90A. For a check-in system 90A, the machine-readable tag 124 may be presented at an entrance way to a merchant's store or in various locations within a particular store. In other exemplary embodiments, the tag 124 may be coupled to individual products within a merchant's premises. In other cases, the tag 124 may be provided on any object in order to initiate a transaction using the portable computing device 100. The tag 124 may be provided on billboards, in printed magazines, etc. In other scenarios, the tag 124 may be displayed on a television screen as part of a TV shopping network. The tag 124 may be provided on Internet Websites adjacent to products/services 44 to facilitate an on-line transaction using the portable computing device 100.

The machine-readable tag 124 may comprise a machine-readable code 222 which may be scanned with a camera 848 of the PCD 100. The payment application 113 running on the PCD 100 may be able to process the scanned machine-readable code 222.

As noted above, the machine-readable code 222 may comprise either a one dimensional or two-dimensional barcode. Further, other machine-readable codes are included within the scope of the invention and may include contactless technologies, such as near-field communications (NFC) which may or may not be linked to a secure-element, and RFID cards as understood by one of ordinary skill in the art. For these contactless technologies, the tag 124 may comprise an antenna 224 coupled to an integrated-circuit chip (not illustrated).

As described above, the tag 124 may provide a unique identifier associated with the electronic cash register 126 and a unique identifier associated with a merchant that operates the electronic cash register 126. These unique identifiers may be contained within the machine-readable code and/or associated with the code. The tag 124 may also comprise a human-readable code 223 that may be keyed-in by the operator of the PCD 100 instead of scanning the machine-readable code 222 with the PCD 100.

FIG. 3A is a diagram of hardware components and software components running on a portable computing device 100 for supporting transactions with the portable computing device 100. The components may include a device identification module 302, a communication hub module 310, an operating system platform (“O/S”) module 312, a global positioning satellite (“GPS”) module 322, a geo-positioning/triangulation module 324, a WiFi detector module 326, a scan module 328, a secure element module 877, and a near field communication module 330.

One of the software components may include the payment application 113. The payment application 113 may further comprise additional modules for rendering visuals on the device display 908. These additional modules may include, but are not limited to, a common display module 314, a retail display module 316, a restaurant display module 31A, and other display modules #N 320. Further details about the additional modules that are part of the payment application 113 will be described below in connection with FIG. 3B.

The device identification module 302 may also comprise submodules such as a device identifier or International Mobile Equipment Identity (“IMEI”) module 304, a subscriber identity module (“SIM”) serial number module 306, and/or a subscriber identifier module or international mobile subscriber identity (“IMSI”) module 308. Usually, a portable computing device 100 would usually have only one of these modules to uniquely identify the portable computing device 100 to the communications network 142 and the central mobile payment controller 50 as understood by one of ordinary skill in the art.

The communication hub module 310 is responsible for relaying information between the device identification module 302 and the central mobile payment controller 50 as well as between the GPS module 322 and the central mobile payment controller 50. The communication hub module 310 may support conventional mobile phone communication protocols as understood by one of ordinary skill in the art.

The GPS module 322 and geo-positioning/triangulation module 324 may assist the central mobile payment controller 50 with determining the physical location of the portable computing device 100. Once the central mobile payment controller 50 is aware of the physical location of the portable computing device 100, the central mobile payment controller 50 may determine in which merchant location the portable computing device 100 is located.

The WiFi detector module 326 may communicate with a WiFi local area network router 142A that is part of a check-in system 90A. The check-in system 90A may allow an operator of the portable computing device 100 to alert the central mobile payment controller 50 when the portable computing device has entered into the location of a merchant. In this way, the central mobile payment controller 50 may be able to provide unique offers to the operator of the portable computing device 100 before the operator decides to complete a transaction for a products/services 44.

The check-in system 90A may further comprise machine-readable tags 124 that include, but are not limited to, a QR barcode tag 124A, and a radiofrequency-identifier (“RF-ID”) tag 124B. These machine-readable tags 124 of the check-in system 90A may be positioned at the entrance of a store and they may be positioned in multiple locations within a store such as in a department store. In a department store example, a machine-readable tag 124 may be positioned within specific different departments such as in hardware and in athletic goods so that the central mobile payment controller 50 may generate unique offers tailored to the department within which the portable computing device 100 is located.

The check-out system 90B may also comprise machine-readable tags 124 that are positioned at each point-of-sale terminal or electronic cash register (“ECR”) 126. Each machine-readable tag 124 of the check-out system 90B, like the check-in system 90A, may comprise a 2-D QR barcode 124A and/or an RFID tag 124B.

The scan module 328 may work in conjunction with the camera 848 of the portable computing device 100. The scan module 328 may process scans of the 2-D QR barcodes that are present on a respective machine-readable tags 124. Similarly, the secure element module 877 and NFC module 330 may work with RFID tag 124B that may be part of either the check-in system 90A or the check-out system 90B. The O/S module 312 may comprise any one of conventional mobile phone operating systems known as of this writing. For example, the O/S module 312 may comprise an android operating system, an iPhone operating system, a Java 2 Platform Micro Edition (“J2ME”) operating system, a Research-In-Motion (“RIM”) operating system, and a Binary Runtime Environment for Wireless (“BREW”) MP operating system as understood by one of ordinary skill in the art.

FIG. 3B is a diagram of several software components for a payment application 113 running on a portable computing device 100. The software components may form the common display module 314, the retail display module 316, and the restaurant display module 318 of FIG. 3A. The software components for the common display module 314 may include, but are not limited to: a splash module 314A, a home screen module 314B, a sign-in module 314C, a password module 314D, a scanning module 314E, a manual scan module 314F, a personal identification number (“PIN”) module 314G, a locations module 314H, an NFC tap module 314I, a search module 314J, a show map module 314K, a store receipts module 314L, a search receipt module 314M, a “my account” module 314N, a preferences module 314O a devices module 314P, a sign-account module 314Q, and a disable account module 314R as understood by one of ordinary skill in the art.

In this example, the splash module 314A performs the user and device authentication check on the display 808, such as a touch screen display, of the PCD 100. The home screen module 314B allows the operator to return to a home screen or default screen for the PCD 100. The sign-in module 314C allows manages any credentials that the operator enters into the PCD 100. The password module 314D reviews any received credentials for a match with the password selected by the operator. The scanning module 314E activates an automatic scanning feature supported by the PCD 100 so that the camera may automatically focus the camera for 848 for reading a tag 124. The manual scan module 314F activates a manual scanning feature in which the operator may control the focus of the camera 848 for reading a tag 124.

The personal identification number (“PIN”) module 314G allows the operator to change his or her PIN as understood by one of ordinary skill in the art. The locations module 314H supports a function in which the PCD 100 may display the closest merchants who support the PCD payment features. The NFC tap module 314I allows an operator to activate NFC functionality of the PCD 100. The search module 314J allows an operator to search for specific transactions that were made using the PCD 100. The show map module 314K may support functions such as a geographical map relative to the location of the PCD 100 as well as maps of building plans for merchants who support payments with the PCD 100.

The store receipts module 314L allows an operator to pull up copies of electronics receipts for any transaction completed by the PCD 100. The search receipt module 314M allows the operator to search for specific electronic receipts that were generated by the PCD 100. The “my account” module 314N allows an operator to review the current balances and pending payments supported by the PCD 100 for transactions completed with the PCD 100. The preferences module 314O allows an operator to display preferences for the account associated with the PCD 100, such as allowing the operator to select a preferred sequence of payment accounts to use with the PCD 100 for a transaction.

The devices module 314P allows an operator to review the multiple PCDs 100 that may be used by the operator to complete transactions. For example, if the operator had a plurality of mobile phones, then the devices module 314P may display a listing of the mobile phones associated with use of the mobile payment account. The sign-account module 314Q may allow operator to enter his or her electronic signature for completing transactions such as ACH transactions which may require an electronic signature. The disable account module 314R may support a function in which an operator may turn off his or her mobile payment account so that unauthorized use may not occur with other PCDs 100 that may be associated with the account.

The software components for the retail display module 316 may include, but are not limited to: a scan tag module 316A, a PIN module 316B, a first waiting module 316C, pay module 316D, a paid module 316E, and in-store module 316F, a list items module 316G, a second waiting module 316H, a paying module 316I, a paid module 316J, a receipt module 316K, and a check-in module 316L as understood by one of ordinary skill in the art.

The scan tag module 316A may automatically activate the camera 848 for focusing on a tag 124. The PIN module 316B may allow operator to change his or her PIN that may be associated only with retail transactions. The first waiting module 316C may activate a timer that an operator may select when he or she is waiting for the ECR 412 to communicate with the central mobile payment controller 50. The pay module 316D may allow the operator to automatically pay a balance when the balance is displayed by the PCD 100. The paid module 316E notifies the operator of the authorization or decline of each form of payment previously selected as well as the overall success or decline of the full transaction. The in-store module 316F may allow the operator to indicate that he or she is present within the store of a merchant prior to checking-in or checking-out using a tag 124. The list items module 316G may allow operator to redisplay any items being checked out for a payment transaction associated with the PCD 100. A second waiting module 316H may be activated by an operator of the PCD 100 when he or she is waiting for their payment options after a total bill for the transaction has been displayed. The paying module 316I displays the amount due along with the selection of applicable tender methods previously loaded to the central mobile payment controller 50. The operator of the PCD is given the opportunity to select one or more methods of payment to satisfy the amount due. The receipt module 316K allows an operator display the electronic receipt associated with the last transaction or the current transaction being processed by the PCD 100. The check-in module 316L may be activated by the operator when she or he is about to use the check-in system 90A of FIG. 1A.

The software components for the restaurant display module 318 may include, but are not limited to: an in-store module 318A, an items full module 318B, an items check module 318C, a partial pay module 318D, a partial paid module 318E, a split check module 318F, an items partial module 318G, and an items remaining module 318H as understood by one of ordinary skill in art.

The in-store module 318A may allow operator to alert the central mobile payment controller 50 that the PCD 100 is present within a restaurant. The items full module 318B displays the full list of items scanned in or otherwise entered by the “sales associate”. The items check module 318C allows an operator of the PCD 100 start a payment process associated with a restaurant transaction so that the operator does not need to wait for a waiter or waitress. The partial pay module 318D allows the operator of the PCD 100 to pay with the PCD 100 in addition to another form of payment not supported by the PCD 100 such as by a physical token like a credit card carried by the operator of the PCD 100. In the case where multiple parties each identify themselves as payors of the full amount due, the partial paid module 318E notifies the each operator of the approval or decline of their portion of the entire amount due. The split check module 318F allows an operator to split a check with another person who may be dining with the operator of the PCD 100. The items partial module 318G displays only the items that have been identified by the operator of the PCD as his/her portion of the full bill. The items remaining module 318H displays all items and remaining amount due that has not yet been satisfied during a split check.

The skinning capability module 332 provides a function for enabling a third party to utilize the full functionality of the system but with the look-n-feel of their choosing.

FIG. 4 is a diagram illustrating details for the merchant point-of-sale (“POS”) system 12 and the merchant enterprise system 16 of FIG. 1 for completing a sales transaction with a portable computing device 100. The merchant POS system 12 may comprise a store controller 410 and an electronic cash register (“ECR”) 412. The ECR 412 may comprise a drawer for storing cash currency. The ECR 412 may also print a receipt 127 for a customer with a printing device, like a printer (not illustrated).

The ECR 412 may be coupled to a handheld (or fixed) scanner 132 which may be used to scan other machine-readable labels attached to one or more products/services 44. The scanner 132 may comprise a bar code reader or any type of similar device used to collect information from machine-readable labels attached to products/services 44.

The ECR 412 may also be coupled to a reader (or terminal) 128, such as a mag-stripe reader or other such device for reading any one of a number of tokens 123 such as credit cards, debit cards, loyalty cards, stored value cards such as gift cards, and the like. For example, the reader 128 may comprise a device that reads magnetic stripes on cards, integrated circuit cards, and near-field-communication (NFC) cards as understood by one of ordinary skill in the art. The reader 128 may be coupled with a keypad 129 so that a consumer may enter appropriate information relative to any token that may be scanned or read by the reader 128.

The ECR 412 is also coupled to the store controller 410. The store controller 410 may support one or more electronic cash registers (ECRs) 126 for a particular location of a merchant. The store controller 410, as understood by one of ordinary skill in the art, may comprise a computer server for tracking and matching scanned product codes with a product inventory database (not illustrated separately) which is maintained by the store controller 410.

The store controller 410 may receive product data that is produced by the product scanner 132 and which is relayed by the ECR 412. The store controller 410 may be responsible for securing authorization for payment from a consumer after a token is read by the POS terminal 128B. The store controller 410 may support one or more product specific languages as understood by one of ordinary skill in the art such as, but not limited to, unified POS and JAVA™ POS.

To secure authorization for payment, such as for a credit or debit card, the store controller 410 communicates the merchant enterprise system 16 via the communications network 142. The merchant enterprise system 16 may comprise an Ewallet system 402, a credit switch 404, a data update module 406, and an enterprise router 408.

As illustrated in FIG. 4, the store controller 410 communicates with the enterprise router 408 of the merchant enterprise system 16. The router 408 may comprise a device that interconnects two or more computer networks, and selectively interchanges packets of data between them, as is understood by one of ordinary skill in the art.

The router 408 of FIG. 4 couples the store controller 410 to credit card system 20A and merchant acquirer 10 for traditional payment processing. The router 408 of FIG. 4 also couples the store controller 410 to alternative payment systems 18. Traditional payment processing may include, but is not limited to, processing payments from accounts associated with traditional credit cards and debit cards. The credit card system 20A may comprise exemplary networks such as the VISA™ credit card network, the MASTERCARD™ card network, the DISCOVER™ credit card network, the AMERICAN EXPRESS™ credit card network, and other similar charge or debit card proprietary networks.

Meanwhile, the alternative payment systems 18 may be responsible for handling and managing non-traditional or alternative payment processing. For example, alternative payment processing may include, but is not limited to, processing payments from accounts associated with certain online financial institutions or other service providers, like PAYPAL™, BILL ME LATER™, Wii™, APPLE™, GREEN DOT™, and mobile phone carriers like SPRINT™ and VERIZON™.

The eWallet system 402 may provide information and support functions for one or more stored value accounts as well as other types of accounts, such as, but not limited to, credit card accounts and bank accounts, as understood by one of ordinary skill in the art. The data update module 406 may allow the merchant enterprise system 162 update its records for any new mobile payment accounts that were used by consumers to pay for transactions.

The electronic cash register (“ECR”) 412 may comprise a plurality of components. These components may include hardware and software modules. Exemplary components include, but are not limited to, a loyalty module 414, a credit module 416, a private-label module 418, a coupons/discounts module 420, a PIN/debit module 422, a check module 424, an item entry module 426, a gift card module 428, a cash module 430, and a mobile payment module 432. The aforementioned components may be selected by an operator of the ECR 412 in order to complete payment for a transaction.

The ECR 412 may be coupled to a product scanner 132 for scanning one-dimensional and two-dimensional barcode labels. The ECR for 12 may also be coupled to a reader 128 that may comprise a magstripe and/or an NFC reader. The ECR 412 may also be coupled to a PIN pad 129 as well as a receipt printer 134 for printing a receipt 127, a sale total monitor 133, and a graphical customer display 131 that may list one items purchased during a transaction.

FIG. 5 is a diagram illustrating details of a merchant acquirer 10, bank card systems 20B, and credit card systems 20A of FIG. 1 for completing a sales transaction. The merchant acquirer 10 may comprise a pass-through module 502 and an authorization/settlement module 504. The pass-through module 502 may pass request for payment authorization information directly to a selected bank card system 20B. Meanwhile, the authorization/settlement module 504 may perform some authentication prior to sending request for payment authorization onto a bank card system 20B.

The merchant acquirer 10 usually supports credit card systems that are provided by financial institutions such as banks. For example, credit card 20B1 may comprise a first bank card like a CHASE™ card from CHASE™ bank while credit card 20B2 may comprise a second bank card like a NATIONS BANK™ card from the NATIONS BANK™ lender. These institutions usually offer their brand of VISA™ and MASTERCARD™ type cards.

Other credit card systems 20A may comprise private-label cards 20A1 as well as traditional travel and entertainment cards 20A2. Private-label cards may include, but are not limited to, merchant based cards 20A1a such as those for specific retail establishments like, THE HOME DEPOT™, WALMART™, NORDSTROM™, SAX™, etc. Traditional travel and entertainment cards 20A2 may include, but are not limited to, DINERS CLUB CARD™, AMERICAN EXPRESS™, and DISCOVER™.

While a direct connection is illustrated between the merchant enterprise system 16 and the credit card systems 20A as well as the merchant acquirer 10, one of ordinary skill in the art recognizes that such a connection may be a virtual one which is supported by the communications network 142. Similarly, a direct connection is illustrated between the merchant enterprise system 16 and the central mobile payment controller 50. This direct connection may also comprise a virtual one supported by the communications network 142 as illustrated in FIG. 1.

FIG. 6 is a diagram illustrating details of a gateway 14 and alternative payment systems 18 illustrated in FIG. 1. The gateway 14 may comprise a traditional gateway module 14A, a gateway vault 14B, and a high-security firewall 633. The high-security firewall 63 provides a secure communication channel between the central mobile payment controller 50 in the gateway 14. A traditional gateway module 14A may comprise a credit switch 602 and a transaction transport module 604.

The traditional gateway module 14A may comprise a payment server as understood by one of ordinary skill in the art. Communications between the central mobile payment controller 50 and the gateway 14 may comprise a secured socket layer (SSL) encrypted connection and may pass through the high-security firewall 633 as understood by one of ordinary skill in the art. Usually, the central mobile payment controller 50 issue commands to the gateway vault 14B to relay account information to the gateway module 14A. The payment gateway module 14A may forward the transaction information to one of the alternative payment systems 18 via the credit switch 602.

Specifically, the credit switch 602 may be responsible for exchanging data with each of the different alternative payment systems 18 illustrated in FIG. 6. The transaction transport module 604 may be responsible for exchanging data with a secure data transport module 618 of the gateway vault 14B.

The gateway vault 14B may comprise track 1/track two data 606, card not present (“CNP”) data 608, merchant gift card data 610, automated clearinghouse (“ACH”) data 612, loyalty data 614, and credentials 616. The gateway vault 14B may also comprise a tokenizer 620. The tokenizer 620 may receive a payment authorization request from the central mobile payment controller 50 in format according to specific industry rules based on the payment accounts stored with or associated with the gateway vault 14B.

The alternative payment systems 18 may comprise various different methods of payment available to the operator of the portable computing device 100 for completing a transaction. The alternative payment systems 18 may comprise internal systems 18A, mobile phone carrier billing 18B, e-commerce vendors 18C, alternate deposit systems 18D, demand deposit schemes 18E, and stored value systems 18F. For example, an internal system 18A may comprise accounts from an Ewallet system for the portable computing device 100, such as SWAGG™ brand of mobile payments offered by Outlier (a subsidiary of QUALCOMM, Incorporated). Mobile phone carrier billing systems 18B may include, but are not limited to, accounts from wireless carriers as of this writing such as, SPRINT™ accounts, AT&T™ accounts, VERIZON™ accounts, etc. e-commerce vendors 18C may include, but are not limited to, accounts from e-commerce vendors like iTUNES™ accounts, GOOGLE™ check out accounts, AMAZON™ payments, BILLMELATER™ accounts, and PAYPAL™ accounts. Alternate deposit systems 18D may include be coupled debit systems 18D1 and the like. Demand deposit systems 188 may include ACH transfers 18E1 and checks 18E2. And stored value systems 18F may include gift cards 18F1 offered by a merchant.

FIG. 7A is diagram illustrating details for the central mobile payment controller 50 illustrated in FIG. 1. The central mobile payment controller 50 manages data between the PCD 100 and the merchant enterprise system 16. The central mobile payment controller may support industry standard compliance measures. For example, the central mobile payment controller may be compliant with Payment Card Industry (“PCI”) standards. In this way, the merchant enterprise system 16 and the PCD 100 do not store any sensitive data such as credit card information and personal information like social security numbers, home addresses, etc. Such sensitive data may be stored in the central mobile payment controller 50.

The central mobile payment controller 50 is also responsible for communicating with a gateway 14 for establishing a connection with alternative payment systems 18. The central mobile payment controller 50 may also relay product scan data sent from the merchant enterprise system 16 over the communications network 142 to the PCD 100. In this way, the PCD 100 may display products individually (merchandise SKU's) on the display of the PCD 100 as they are scanned in by the product scanner 132 of the merchant POS system 12. The central mobile payment controller 50 may also relay identification (loyalty), promotions (offers/discounts), and payment information between the PCD 100 and merchant POS system 12 as described in further detail below.

The central mobile payment controller 50 may comprise a payment communication module 730, a user data store module 732, a system datastore module 734, a merchant data store module 736, a rules engine 737, an advertising API 720B, an advertising transport module 728, a loyalty API 720C, a loyalty transport module 746, a portal API 720D, a portal communications module 748, a client API 720E, a client device communications module 750, a merchant API 720F, and a merchant enterprise communications module 752.

The payment communications module 730 may support the communications between the central mobile payment controller 50 and the gateway 14 that is coupled to the alternative payment systems 18. While a direct connection between the central mobile payment controller 50 and the gateway 14 is illustrated, one of ordinary skill in the art recognizes that this direct connection may be a virtual one using the communications network 142 of FIG. 1. The user data store module 732 may comprise a plurality of submodules that include, but are not limited to, a demographics submodule 732A, a device management module 732B, a line item and purchase data module 732C, a preferences module 732D, a vault mappings module 732E, and an Ewallet module 732F.

The demographics submodule 732A may track preferences of the operator of the PCD 100 as well as characterizations made by the PCD 100 about the possible race, age, and gender of the operator. The device management module 732B may support functions for associating multiple pcds 100 with the mobile payment accounts of a single operator. The line item and purchase data module 732C may track all purchases made with the portable computing device 100. The preferences module 732D may store and support any new preferences requested by the operator using a PCD 100. The vault mappings module 732E may support request for payments from payment accounts associated with the gateway vault 14B of FIG. 1. An Ewallet module 732F supports request for managing in a walled account associated with a particular PCD 100.

The system datastore module 734 may comprise a plurality of submodules that include, but are not limited to, a transaction log module 734A, a merchant management module 734B, a user management module 734C, a device management module 734D, and a vault mappings module 734E.

The transaction log module 734A may automatically record and store the line items associated with each transaction paid with the portable computing device 100. The merchant management module 734B may automatically record and store the various merchants which received payment from the portable computing device 100.

The user management module 734C may allow the operator of the PCD 100 to manage various functions and options that are selectable for a given mobile count. The device management module 734D may support functions for associating multiple pcds 100 with the mobile payment accounts of a single operator. The vault mappings module 734E may support request for payments from payment accounts associated with the gateway vault 14B of FIG. 1.

Similarly, the merchant data store module 736 may comprise a plurality of submodules that include, but are not limited to, a location demographics module 736A, a graphic assets module 736B, tag mappings module 736C, and accepted payment options module 736D, a preferences module 736E, and MID mappings module 736F.

The location demographics module 736A may track the various merchant locations that are receiving payments with the PCD 100 for completing transactions. The graphic assets module 736B may support the various graphical elements such as artwork and icons associated with the credit cards. The tag mappings module 736C may store the various specific tags 124 that may be scanned with the PCD 100. The accepted payment options module 736D may control the listing of payment options that are displayed on the PCD 100 when a final amount is listed as due for a transaction. The preferences module 736E may store various preferences from merchants such as payment types and costs associated with each payment type that may be selected by an operator of a PCD 100. The merchant ID (“MID”) mappings module 736F associates the system's single “enterprise” relationship to each of the merchant's individual store locations.

The rules engine 737 may also comprise a plurality of modules. Exemplary modules include, but are not limited to, a loyalty sign-in module 738, a balance display module 740, targeted offers module 742, and a tender steering module 744. The loyalty sign-in module 738 may be responsible for automatically retrieving loyalty data associated with the portable computing device 100. The balance display module 740 may be responsible for sending the data to the display 808 of the portable computing device 100. Such data may include product scan data received from the merchant enterprise system 16 as well as the final total do for products/services 44 that are to be purchased using the portable computing device 100.

The targeted offers module 742 may be responsible for automatically retrieving offers and coupons from the offer/coupon system 22 based on the current location of the portable computing device as well as any products/services 44 that have been scanned in for purchase by the merchant POS system 12. The tender steering module 744 may be responsible for automatically displaying the options for paying for a particular transaction. The options would include those associated with the alternative payment systems 18 as well as the traditional payment systems 20 that are associated with the operator of the portable computing device 100.

The advertising transport module 728 may support communications between the central mobile payment controller 50 and the offer/coupon system 22. While a direct connection between the central mobile payment controller 50 and the offer/coupon system 22 is illustrated, one of ordinary skill in the art recognizes that this direct connection may be a virtual one using the communications network 142 of FIG. 1. The advertising transport module 728 establishes communications with the offer/coupon system 22 through an advertising API 720B.

The offer/coupon system 22 may comprise a plurality of modules. Exemplary modules include, but are not limited to, third-party offer generators 702A-D as well as a system account manager 704. The offer/coupon system 22 that produces targeted coupons based upon specific products purchased by a consumer. The third-party offer generator 702 may comprise modules supported by Catalina Marketing, Inc., SWAGG™ from Outlier (a subsidiary of Qualcomm, Incorporated), YOWZA!™, Mobilecoupon.com, and GROUPON™ brand of offers/coupons. Other types of offer/coupon system 22 are within the scope of the disclosure is understood by one or a skill in the art.

The offer/coupon system 22 may further comprise a merchant's module 712, a consumer packaged goods (“CPG”) module 714, a manufacturers module 716, and a GOOGLE™ module 718.

The loyalty transport module 746 may be responsible for supporting the communications between the central mobile payment controller 50 and the loyalty system 24. While a direct connection between the central mobile payment controller 50 and the loyalty system 24 is illustrated, one of ordinary skill in the art recognizes that this direct connection may be a virtual one using the communications network 142 of FIG. 1. The loyalty transport module 746 exchanges communications through the loyalty API 720C.

The portal communications module 748 may be responsible for supporting communications between the central mobile payment controller 50 and the online portals 26-32. While a direct connection between the central mobile payment controller 50 and the online portals 26-32 is illustrated, one of ordinary skill in the art recognizes that this direct connection may be a virtual one using the communications network 142 of FIG. 1. The online portals 26-32 will be described in further detail below in connection with FIG. 7B.

The client device communications module 750 may support communications between the central mobile payment controller 50 and the portable computing device 100. While a direct connection between the central mobile payment controller 50 and the portable computing device 100 is illustrated, one of ordinary skill in the art recognizes that this direct connection may be a virtual one using the communications network 142 of FIG. 1. The client device communications module 750 may establish communications with the portable computing device 100 through a client API 720E. Specifically, the client device communications module 750 may establish a persistent communication with the portable computing device 100 that may be characterized as a form of secure chat messaging.

The merchant enterprise communications module 752 may support communications between the central mobile payment controller 50 and the merchant enterprise system 16. While a direct connection between the central mobile payment controller 50 and the merchant enterprise system 16 is illustrated, one of ordinary skill in the art recognizes that this direct connection may be a virtual one using the communications network 142 of FIG. 1. The merchant enterprise communications module 752 may establish communications with the merchant enterprise system 16 by using a merchant API 720F. A secure communication channel may be established over the communications network 142 between the merchant enterprise communications module 752 and the merchant enterprise system 16 as understood by one of ordinary skill in the art.

All of the inbound and outbound communications for the central mobile payment controller 50 may pass through firewall/security layers 722A-F as understood by one of ordinary skill in the art. Each firewall/security layer 722 may comprise a device or set of devices designed to permit or deny network transmissions based upon a set of rules.

FIG. 7B is a diagram illustrating several online portals 26-32 for managing the transaction management system 101 according to one exemplary embodiment of the invention. The transaction management system 101 may comprise a mobile payment enrollment portal 26, a consumer mobile payment portal 28, a merchant store-specific mobile payment portal 30, and a merchant store-wide mobile payment management portal 32. Each of these portals 26, 28, 30, 32 may be coupled to the central mobile payment controller 50. While a direct connection as illustrated between the portals 26, 28, 30, 32 and the central mobile payment controller 50, one of ordinary skill in the art recognizes that this direct connection may be a virtual one that is established over the communications network 142. The communications between the central mobile payment controller 50 and each of the respective portals 26, 28, 30, 32 may be shielded with an appropriate firewall/security layer 722A as understood by one of ordinary skill in the art.

The mobile payment enrollment portal 26 may allow a consumer to open an account with their portable computing device 100. The mobile payment enrollment portal 26 may also allow a merchant to open account so that particular store locations may be managed by the transaction management system 101. The mobile payment enrollment portal 26 may comprise a teaser site module 26A, a public website module 26B, a merchant request module 26C, and a user registration module 26D. The merchant request module 26C may support the enrollment for a merchant who wishes to access the services provided by the transaction management system 101. The user registration module 26D may support the enrollment of individual consumers or operators of the pcds 100.

The consumer mobile payment portal 28 may comprise an enrollment module 28A, a cards module 28B, a devices module 28C, a favorites module 28D, in account preferences module 28E, and a reporting module 28F.

The merchant store-specific mobile payment portal 30 may comprise a location demographics module 30A, a graphics assets module 30B, an account preferences module 30C, a tender preferences module 30D, a reporting module 30E, and an advertising distribution rules module 30F.

The merchant store-wide mobile payment management portal 32 may comprise a merchant management module 32A, a user management module 32B, a payment management module 32C, a system preferences module 32D, and a reporting module 32E.

Referring to FIG. 8, an exemplary, non-limiting aspect of a portable computing device (“PCD”) is shown and is generally designated 100. As shown, the PCD 100 includes an on-chip system 822 that includes a multicore CPU 802. The multicore CPU 802 may include a zeroth core 810, a first core 812, and an Nth core 814.

As illustrated in FIG. 8, a display controller 828 and a touch screen controller 830 are coupled to the multicore CPU 802. In turn, a display 808 external to the on-chip system 822 is coupled to the display controller 828 and the touch screen controller 830. An NFC antenna 879 may be coupled to the CPU 802 and may support functions that work in combination with a secure element module 877. The secure element module 877 may comprise software and/or hardware and/or firmware as understood by one of ordinary skill in the art.

FIG. 8 further shows that a video encoder 834, e.g., a phase alternating line (“PAL”) encoder, a sequential color a memoire (“SECAM”) encoder, or a national television system(s) committee “(NTSC”) encoder, is coupled to the multicore CPU 802. Further, a video amplifier 836 is coupled to the video encoder 834 and the touch screen display 108. Also, a video port 838 is coupled to the video amplifier 836. As shown in FIG. 8, a universal serial bus (“USB”) controller 840 is coupled to the multicore CPU 802. Also, a USB port 842 is coupled to the USB controller 840. Memory 404A and a subscriber identity module (“SIM”) card 846 may also be coupled to the multicore CPU 802.

Further, as shown in FIG. 8, a camera 848 may be coupled to the multicore CPU 802. In an exemplary aspect, the camera 848 is a charge-coupled device (“CCD”) camera or a complementary metal-oxide semiconductor (“CMOS”) camera.

As further illustrated in FIG. 8, a stereo audio coder-decoder (“CODEC”) 850 may be coupled to the multicore CPU 802. Moreover, an audio amplifier 852 may coupled to the stereo audio CODEC 850. In an exemplary aspect, a first stereo speaker 854 and a second stereo speaker 856 are coupled to the audio amplifier 852. FIG. 8 shows that a microphone amplifier 858 may be also coupled to the stereo audio CODEC 850. Additionally, a microphone 860 may be coupled to the microphone amplifier 858. In a particular aspect, a frequency modulation (“FM”) radio tuner 862 may be coupled to the stereo audio CODEC 850. Also, an FM antenna 864 is coupled to the FM radio tuner 862. Further, stereo headphones 866 may be coupled to the stereo audio CODEC 850.

FIG. 8 further illustrates that a radio frequency (RF) transceiver 868 may be coupled to the multicore CPU 802. An RF switch 870 may be coupled to the RF transceiver 868 and an RF antenna 872. As shown in FIG. 4C, a keypad 874 may be coupled to the multicore CPU 802. Also, a mono headset with a microphone 876 may be coupled to the multicore CPU 802. Further, a vibrator device 878 may be coupled to the multicore CPU 802. FIG. 8 also shows that a power supply 880 may be coupled to the on-chip system 822. In a particular aspect, the power supply 880 is a direct current (DC) power supply that provides power to the various components of the PCD 100 that require power. Further, in a particular aspect, the power supply is a rechargeable DC battery or a DC power supply that is derived from an alternating current (AC) to DC transformer that is connected to an AC power source.

FIG. 8 further shows that the PCD 100 may also include a network card 888 that may be used to access a data network, e.g., a local area network, a personal area network, or any other network. The network card 888 may be a Bluetooth network card, a WiFi network card, a personal area network (PAN) card, a personal area network ultra-low-power technology (PeANUT) network card, or any other network card well known in the art. Further, the network card 888 may be incorporated into a chip, i.e., the network card 888 may be a full solution in a chip, and may not be a separate network card 888.

As depicted in FIG. 8, the display 808, the video port 838, the USB port 842, the camera 848, the first stereo speaker 854, the second stereo speaker 856, the microphone 860, the FM antenna 864, the stereo headphones 866, the RF switch 870, the RF antenna 872, the keypad 874, the mono headset 876, the vibrator device 878, and the power supply 880 are external to the on-chip system 822.

In a particular aspect, one or more of the method steps described herein may be stored in the memory 803 as well as in the central mobile payment controller 50, merchant enterprise system 16, merchant POS system 12, and other storage devices as computer program instructions. These instructions may be executed by the multicore CPU 802, central mobile payment controller 50, merchant enterprise system 16, and merchant POS system 12 in order to perform the methods described herein. Further, the multicore CPU 802, merchant enterprise system 16, merchant POS system 12, other storage devices, and memory 803 of the PCD 100, or a combination thereof may serve as a means for executing one or more of the method steps described herein.

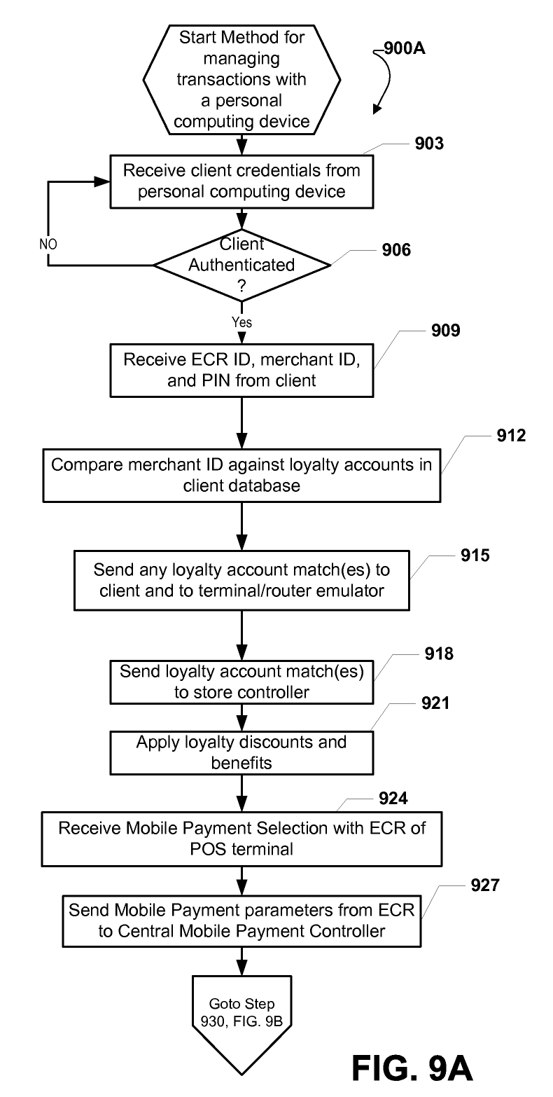

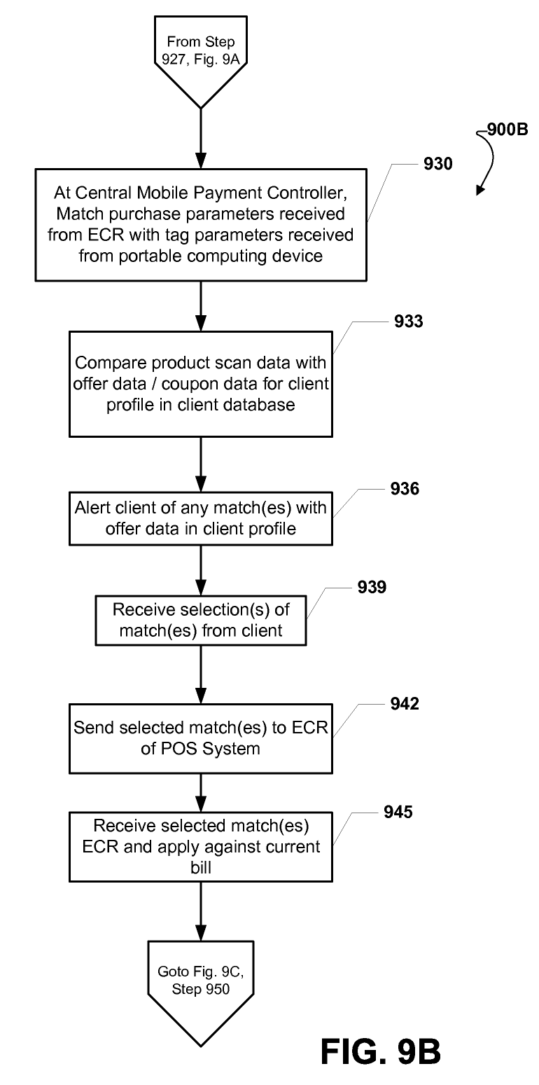

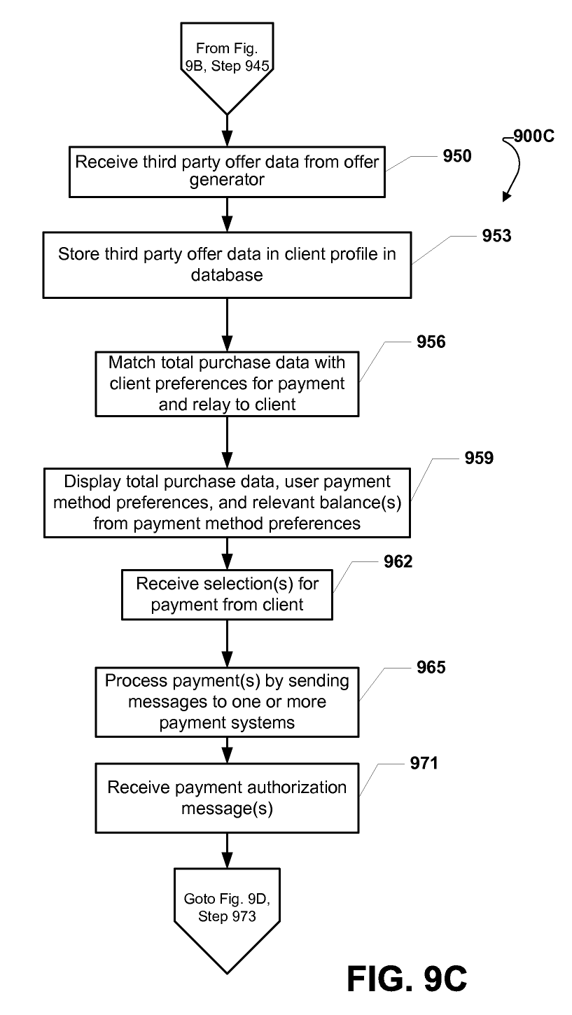

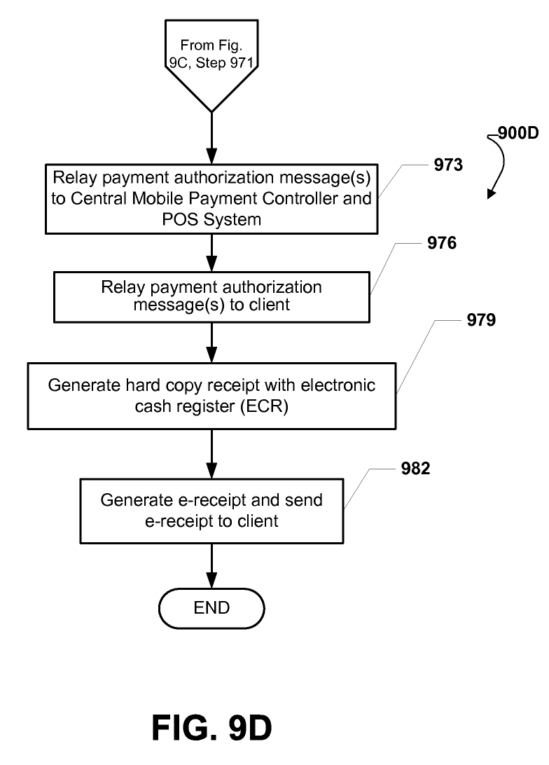

FIG. 9A is a flowchart illustrating a method 900A for managing transactions with a PCD 100. Block 903 is the first step in the process 900 for managing transactions with the PCD 100. In block 903, the client credentials entered in screens 202A and 202B of FIGS. 2A-2B are received by the central mobile payment controller 50 from the portable computing device (PCD) 100. As noted previously, the client credentials may comprise a user name 204, a password or personal identification number (“PIN”) 206, and a unique identifier assigned to the PCD 100.

Next, in decision block 906, the central mobile payment controller 50 determines if the client is authenticated based on the credentials that it received in block 903. In this decision block 906, the central mobile payment controller 50 may verify that the user name 204 of screen 202A matches the unique client identifier assigned to the PCD 100 which is maintained in the system datastore module 734 of FIG. 7A. The system datastore module 734 may comprise a client database containing client profiles associated with PCDs 100. If the central mobile payment controller 50 verifies that the user name 204 matches the client unique identifier assigned to the PCD 100, then the central mobile payment controller 50 checks to see if the password or PIN 206 of screen 202B matches the user name 204 of screen 202A based on a review of the client profile stored in the system datastore module 734.

If the inquiry to decision block 906 is negative, then the “No” branch is followed back to block 903 for receiving the client's credentials for a predetermined number of times. If the inquiry to decision block 906 is positive, then the “Yes” branch is followed to block 909 in which the ECR 412 or terminal identifier, merchant identifier, and PIN are received from the PCD 100. In this block, the PCD 100 may conduct a scan of the tag 124 that comprises the machine-readable code 222 which contains the ECR 412 or terminal identifier as well as the merchant identifier.

Subsequently, in block 912, the central mobile payment controller 50 may compare the merchant identifier received against the loyalty data stored in the loyalty system 24. In this block 912, the payment controller may issue a request for data to the loyalty system 24 using the client identifier.

If the central mobile payment controller 50 determines that there is one or more matches between any loyalty account data received from the loyalty system 24 and the merchant identifier, then in block 915 the central mobile payment controller 50 sends the loyalty account data over the communications network 142 to the portable computing device 100. The portable computing device 100 may display the amount of loyalty points earned and/or used for a particular transaction. If the operator of the PCD 100 has not been enrolled in the loyalty system 24 for a particular merchant, the central mobile payment controller 50 may facilitate the enrollment of the operator at this stage.

In block 918, the central mobile payment controller 50 sends the loyalty account data to the ECR 412 of the merchant POS system 12 by using the terminal identifier. Next in block 921, when the ECR 412 receives the loyalty account data, the ECR 412 may apply appropriate discounts and/or benefits. The application of the discounts and/or benefits may be based on the products/services 44 purchased by the operator of the PCD 100 or they may be based on other factors or a combination of factors such as the number of re-occurrences of purchasing products from the merchant.

Next, in block 924, the central mobile payment controller 50 may receive a signal from the ECR 412 of the merchant POS system 12 that a mobile payment option has been selected. This signal is usually generated by an employee of the merchant who is operating the ECR 412.

Next, in block 927, one or more mobile payment parameters and the product scan data may be sent from the ECR 412 to the central mobile payment controller 50. The one or more mobile payment parameters may comprise a total due, a transaction identifier, a terminal identifier, a merchant identifier, and the sequence number. The process then continue continues to block 930 of FIG. 9B.

FIG. 9B is a continuation flowchart corresponding to the flowchart of FIG. 9A which illustrates a method 900B for managing transactions with a PCD 100. Block 930 is the first block of this continuation flowchart for managing transactions with the PCD 100. In block 930, the central mobile payment controller 50 matches the purchase parameters received from the ECR 412 with the parameters from the tag 124 received from the portable computing device. As noted previously, the purchase parameters received from the ECR 412 may comprise the total amount due for the transaction, a transaction identifier, a terminal identifier, a merchant identifier, and a sequence number. The parameters from the tag 124 relayed by the portable computing device 100 may comprise a terminal identifier, the merchant identifier, and the PIN for the portable computing device 100. If these two sets of parameters do not match, the central mobile payment controller 50 would stop the transaction from being completed and would not display any options for payment on the portable computing device 100.

Next, in block 933, the central mobile payment controller 50 may compare the received product scan data with offer data as well as with the coupon data received from the loyalty system 24 and already stored in a client profile. In block 936, the central mobile payment controller 50 may alert the PCD 100 of any matches with the offer data and coupon data. Specifically, the central mobile payment controller 50 may generate a message that is formatted and received by the PCD 100 and displayed as a selectable option as illustrated in screen 202F as illustrated in FIG. 2F.

However, according to one exemplary embodiment and similar to the selectable option for displaying product scan data described above, a user or operator of PCD 100 may select an option for turning “off” the display of offer data and coupon data matches. According to another exemplary embodiment or the same exemplary embodiment in which the display of offer data and coupon data matches is turned “off”, the user or operator of PCD 100 may elect for the central mobile payment controller 50 to automatically apply matches between coupon data and products/services 44 purchased as well as for matches between the offer data and products/services 44 purchased. These options or preferences for handling and displaying data may part of a client profile which may be stored in the user datastore 732 of FIG. 7A, and particularly, the preferences module 732D. The redeemed coupons may also be sent back through the central mobile payment controller 50 to the appropriate electronic redemption used by the merchant. Alternatively, the redeemed coupons may be sent over the communications network 142 to the appropriate electronic redemption used by the merchant as understood by one of ordinary skill in the art.

In block 939, the central mobile payment controller 50 may receive one or more selection(s) of match(es) from the PCD 100 in response to the operator of PCD 100 selecting one or more options displayed in screen 202F of FIG. 2F. In block 942, the central mobile payment controller 50 sends any user selected match(es) over the communications network 142 and the communication links 103 to the ECR 412 of the merchant POS system 12. The process then proceeds to block 950 of FIG. 9C.

FIG. 9C is a continuation flowchart corresponding to the flowchart of FIG. 9B which illustrates a method 900C for managing transactions with a PCD 100. Block 950 is the first block of this continuation flowchart for managing transactions with the PCD 100. In block 950, the central mobile payment controller 50 may receive third-party offer data produced by a third-party offer generator 702 of the offer/coupon system 22. As described previously, a third-party offer generator 702 may comprise off-the-shelf units, such as, but not limited to, units/modules sold as of this writing by Catalina Marketing, Inc. The offers produced by the third-party offer generator 702 may comprise coupons targeted for a particular operator of PCD 100 based upon the products/services 44 that are purchased and recorded by the product scanner 132 and the ECR 412. The offer/coupon system 22 may also generate private label offers for new credit cards such as a credit card bearing the name of the merchant, such as a WALMART™ or TARGET™ credit card. The

In block 953, the central mobile payment controller 50 may take the received third-party offer data and store it in a storage device corresponding to a particular profile of the operator of the PCD 100. Next, in block 956, the central mobile payment controller 50 may match the total due with the client preferences for payment stored in the user preference data of the preferences module 732D of FIG. 7A. The central mobile payment controller 50 may then relay this client preference for payment methods to the PCD 100.

In block 959, the total purchase data, user payment method references, and relevant balances from the payment method preferences may be displayed on the screen 202G as illustrated in FIG. 2G and generally designated by reference numeral 218A. Next, in block 962, the central mobile payment controller 50 may receive one or more selection(s) for the payment methods over the communications network 142 from the PCD 100 based on selections made by the operator of PCD 100.

Next, in block 965, the central mobile payment controller 50 may process the selected payment methods by sending messages to one or more payment systems 18 and 20 via the gateway 14 and/or the merchant enterprise system 16. Specifically, the central mobile payment controller 50 may send messages to the gateway 14 if one or more alternative payment systems 18, such as, but not limited to, PAYPAL™ brand of online financial payment solutions and SPRINT™ brand of mobile telephone networks, have been selected by the operator of the PCD 100 for paying the final amount due for a purchase. The central mobile payment controller 50 may also send information related to traditional payment systems 20, such as, but not limited to conventional credit card accounts via the communications network 142.

Next in block 971, the central mobile payment controller 50 may receive payment authorizations from any of the payment systems 18 and 20. The process then continues to block 973 of FIG. 9D.

FIG. 9D is a continuation flowchart corresponding to the flowchart of FIG. 9C which illustrates a method 900D for managing transactions with a PCD 100. Block 973 is the first block of this continuation flowchart for managing transactions with the PCD 100. In block 973, the central mobile payment controller 50 may relay the payment authorization messages from the alternative payment systems 18 and traditional payment systems 20 to the ECR 412 of the merchant POS system 12 via the merchant enterprise system 16. In block 976, the central mobile payment controller 50 may also relay the payment authorization messages from the alternative payment systems 18 as well as the payment authorization messages from the traditional payment systems 20 over the communications network 142 to the PCD 100.

Next, in block 979, the electronic cash register (“ECR”) 412 of the merchant POS system 12 may generate a hard copy receipt 127. Similarly, in block 982, the central mobile payment controller 50 may generate an electronic receipt and send it over the communications network 142 to the PCD 100 for display on the display 808 of the PCD 100 as illustrated in screen 202H of FIG. 2H. The process then ends.

The system 101 may generally support businesses such as restaurants or other establishments which may provide products as well as services and which usually do not employ a product scanner 132 coupled to ECR 412. In this exemplary operating environment, other differences include ECR 412 not being present. However, one of ordinary skill in the art recognizes that in some restaurant environments, depending upon the owner's preferences, may include ECR 412 without departing from the scope of this disclosure. In some restaurant environments, terminals may provided and are coupled to the store controller 410. The terminals may comprise token readers, such as magnetic-stripe readers, attached to or integral with the housing of the terminals as understood by one of ordinary skill in the art.

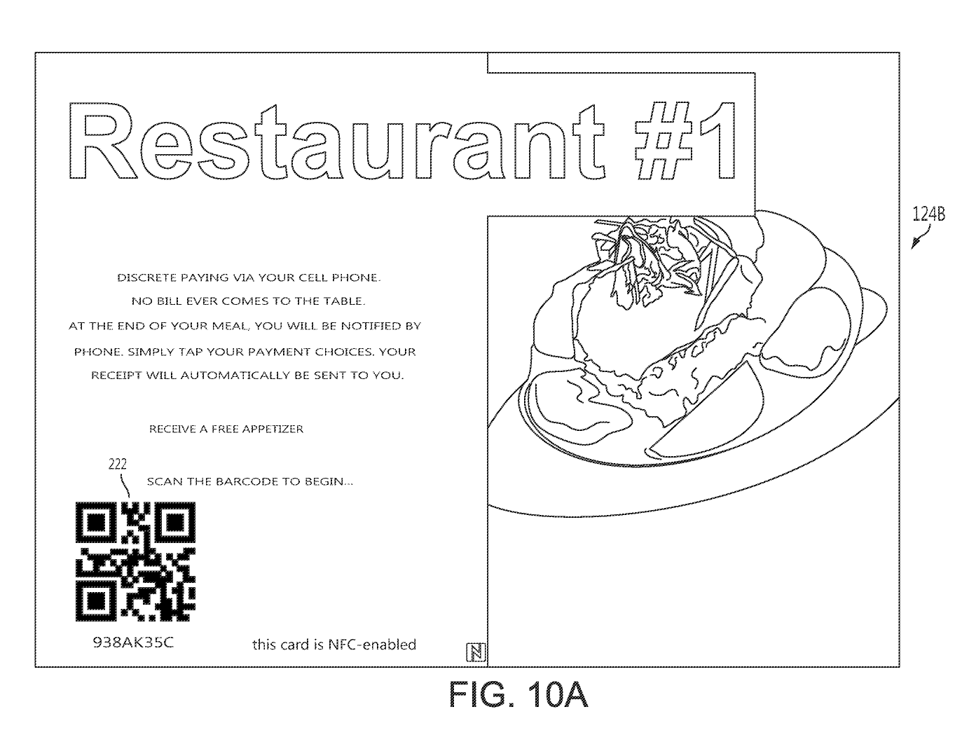

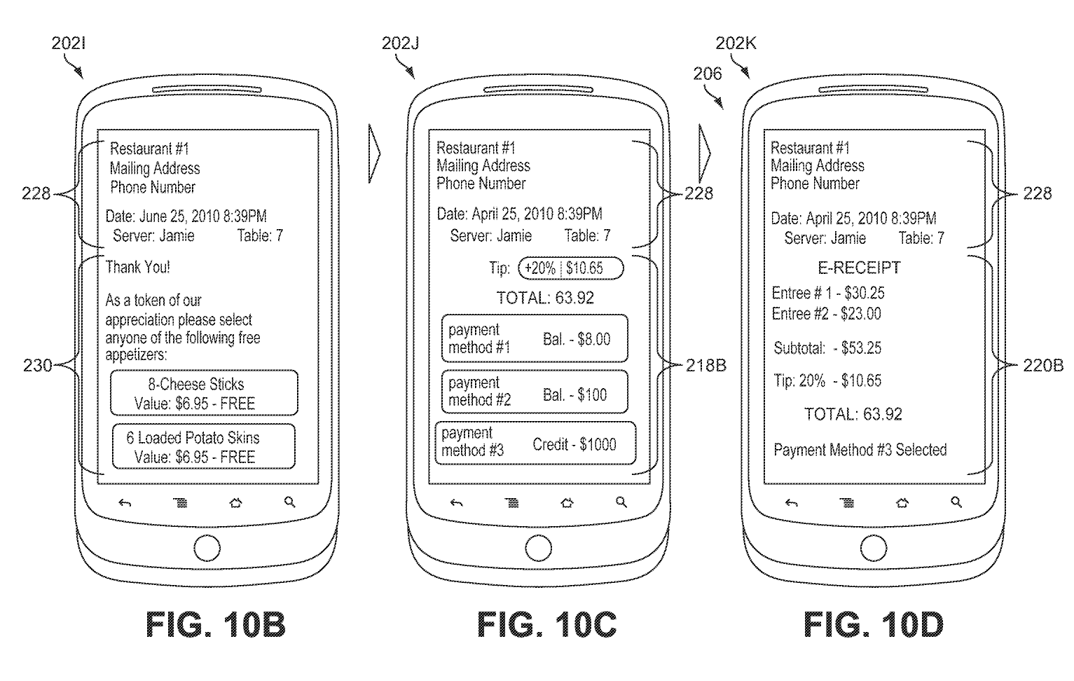

In the exemplary embodiment illustrated in FIG. 10A, a machine-readable tag 124 may be placed on a table in a restaurant so that it may be scanned in with a PCD 100 running the payment application 113. The machine-readable tag 124 may be part of a menu or a display component that is very accessible to an operator of the PCD 100 when he or she is seated at a table in the restaurant.

In the exemplary embodiment illustrated in FIG. 10A, the machine-readable code 222 may be integral with an advertisement about the restaurant. The advertisement may also convey an offer which may be available to an operator of a PCD 100. To encourage patrons of the restaurant to utilize the system 101 instead of traditional card tokens associated with traditional forms of payment, the restaurant may entice the operators of PCDs 100 with special offers such as an offer for a free appetizer if the operator of the PCD 100 scans the machine-readable code 222 with the PCD 100 in order to indicate that the patron will likely pay his or her final bill with the PCD 100.

In response to scanning the machine-readable code 222 of FIG. 10, the central mobile payment controller 50 may generate a message and send the message to the display of the PCD 100 as illustrated in FIG. 10B.

FIG. 10B is a diagram of a screen 202I that shows relevant merchant information 228 and options 230 for an offer from a merchant that may be selected by an operator prior to the end of a transaction. The options 230 for the offer may include one or more choices of food products sold by the restaurant which is utilizing the system 101. In the exemplary embodiment illustrated in FIG. 10B, the choices of food products include, but are not limited to, free cheese sticks and free potato skins.

Once an option 230 is selected by an operator of the PCD 100, the PCD 100 may relay this information back to the store controller 410 which in turn relays this information upstream to the central mobile payment controller 50 as well as any server terminals in the restaurant. A waiter or service professional monitoring the terminal may be provided with a display of the appetizer selected by the operator of the PCD 100. Along these lines, in other exemplary embodiments, the operator of the PCD 100 may also select all of their food items from a menu by scanning in machine-readable codes from the menu or by keying-in codes or names of food items listed in the menu.

FIG. 10C is a diagram of a screen 202J that shows merchant information 228 relevant to a transaction and payment options 218B for a purchase along with a plurality of payment options that may be selected by an operator of the PCD 100. The payment options 218B comprising the plurality of payment options that may be selected by the operator is very similar to the payment options 218A described above in connection with FIG. 2G. As noted previously, one or more payment options may be selected by the operator with this screen 202J. The payment options may also provide or display any remaining balances available with credit card accounts as well as balances available for debit accounts so that the operator will know if there are sufficient funds in respect of accounts to pay for the final bill. Also with this screen 202J, a drop-down menu 229 may be provided for display and selection of an appropriate amount of tip corresponding to the service provided at the merchant such for the service provided by a waiter at a restaurant.

FIG. 10D is a diagram of a screen 202K that shows electronic receipt 220B that may be provided upon completion of a transaction with a merchant, such as a restaurant. The electronic receipt 220B of screen 202K is very similar to the electronic receipt 220A of screen 202H noted above. The electronic receipt 220B may list the food products purchased, as well as the tip for service selected, a total bill amount, and the payment method which was selected for the transaction.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments for the process 900 and system 101 for managing transactions with the PCD 100 will become apparent to one of ordinary skill in the art to which the invention pertains without departing from its spirit and scope. For example, the PCD 100 may be used for making purchases in an on-line transaction environment. In such environments, the on-line merchant may provide the merchant identifier and/or terminal identifier on the merchant's website/webpages which may be scanned-in by the PCD 100 or keyed-in by the operator of the PCD 100. The contents of the merchant's on-line shopping cart may then be displayed on the PCD 100 similar to the brick and mortar POS transactions described above. The operator of the PCD 100 may also select preferred payment methods also like the brick and mortar POS transactions described above.

According to another exemplary embodiment, instead of the central mobile payment sending data to the PCD 100 to form payment screens of FIGS. 2F-2H and FIGS. 10B-10D, this data may be sent to the ECR 412 or POS terminal (PIN PAD/Card Swiper) for display. In this way, the PCD 100 is only used to authenticate a user so that all payment screens are display and rendered on the Merchant side of the system 101.

Therefore, although selected aspects have been illustrated and described in detail, it will be understood that various substitutions and alterations may be made therein without departing from the spirit and scope of the present invention, as defined by the following claims.

What is claimed is:

1. A method for managing transactions with a portable computing device, the method comprising:
verifying credentials for gaining access to a central mobile payment controller;
receiving a merchant identifier corresponding to a merchant from a computer communications network;
comparing the merchant identifier against loyalty account data stored in a database;
identifying and sending any matches of the merchant identifier to loyalty account data over the computer communications network; and
generating a message that lists one or more preferred payment options that may be selected to complete a purchase.

2. The method of claim 1, further comprising: receiving product scan data and comparing the product scan data against one of offer data and coupon data in a database.

3. The method of claim 2, further comprising: sending any matches of product scan data to offer data or coupon data over the computer communications network.

4. The method of claim 1, further comprising: generating a message that lists one or more preferred payment options based on operator preferences listed in a client profile.

5. The method of claim 4, wherein the one or more preferred payment options comprises account information corresponding to at least one of a credit card account, a debit card account, a checking account, a savings account, and a stored value account.

6. The method of claim 1, further comprising: processing a request to pay for a purchase from a non-traditional payment method comprising one of an on-line financial institution and a mobile phone service carrier.

7. The method of claim 1, further comprising: generating an offer for a private label credit card.

8. The method of claim 1, further comprising: displaying one or more preferred payment options on a display device of the personal computing device.

9. The method of claim 1, further comprising: generating one or more offers based on one or more products being purchased and storing the offers in a database.

10. The method of claim 1, wherein merchant identifier is part of a machine-readable tag, the machine-readable tag being attached to a physical object or being projected in an image on a display device.

11. A computer system for managing transactions with a portable computing device, the system comprising:
a processor operable for:
verifying credentials for gaining access to a central mobile payment controller;
receiving a merchant identifier corresponding to a merchant from a computer communications network;
comparing the merchant identifier against loyalty account data stored in a database;
identifying and sending any matches of the merchant identifier to loyalty account data over the computer communications network; and
generating a message that lists one or more preferred payment options that may be selected to complete a purchase.

12. The system of claim 11, wherein the processor is further operable for receiving product scan data and comparing the product scan data against one of offer data and coupon data in a database.

13. The system of claim 12, wherein the processor is further operable for sending any matches of product scan data to offer data or coupon data over the computer communications network.

14. The system of claim 11, wherein the processor operable for generating a message that lists one or more preferred payment options based on operator preferences listed in a client profile.

15. The system of claim 14, wherein the one or more preferred payment options comprises account information corresponding to at least one of a credit card account, a debit card account, a checking account, a savings account, and a stored value account.

16. The system of claim 11, wherein the processor operable for processing a request to pay for a purchase from a non-traditional payment method comprising one of an on-line financial institution and a mobile phone service carrier.

17. The system of claim 11, wherein the processor is further operable for generating an offer for a private label credit card.

18. The system of claim 11, wherein the processor is further operable for displaying one or more preferred payment options on a display device of the personal computing device.

19. The system of claim 11, wherein the processor is further operable for generating one or more offers based on one or more products being purchased and storing the offers in a database.

20. The system of claim 11, wherein merchant identifier is part of a machine-readable tag, the machine-readable tag being attached to a physical object or being projected in an image on a display device.

21. A computer system for managing transactions with a portable computing device, the system comprising:
means for verifying credentials for gaining access to a central mobile payment controller;
means for receiving a merchant identifier corresponding to a merchant from a computer communications network;
means for comparing the merchant identifier against loyalty account data stored in a database;
means for identifying and sending any matches of the merchant identifier to loyalty account data over the computer communications network; and
means for generating a message that lists one or more preferred payment options that may be selected to complete a purchase.

22. The system of claim 21, further comprising:
means for receiving product scan data and comparing the product scan data against one of offer data and coupon data in a database.

23. The system of claim 22, further comprising:
means for sending any matches of product scan data to offer data or coupon data over the computer communications network.

24. The system of claim 21, further comprising:
means for generating a message that lists one or more preferred payment options based on operator preferences listed in a client profile.

25. The system of claim 24, wherein the one or more preferred payment options comprises account information corresponding to at least one of a credit card account, a debit card account, a checking account, a savings account, and a stored value account.

26. The method of claim 21, further comprising:
means for processing a request to pay for a purchase from a non-traditional payment method comprising one of an on-line financial institution and a mobile phone service carrier.

27. The system of claim 21, further comprising:
means for generating an offer for a private label credit card.

28. The system of claim 21, further comprising:
means for displaying one or more preferred payment options on a display device of the personal computing device.

29. The system of claim 21, further comprising:
means for generating one or more offers based on one or more products being purchased and storing the offers in a database.

30. The system of claim 21, wherein merchant identifier is part of a machine-readable tag, the machine-readable tag being attached to a physical object or being projected in an image on a display device.

31. A computer program product comprising a computer usable medium having a computer readable program code embodied therein, said computer readable program code adapted to be executed to implement a method for managing transactions with a portable computing device, said method comprising:
verifying credentials for gaining access to a central mobile payment controller;
receiving a merchant identifier corresponding to a merchant from a computer communications network;
comparing the merchant identifier against loyalty account data stored in a database;
identifying and sending any matches of the merchant identifier to loyalty account data over the computer communications network; and
generating a message that lists one or more preferred payment options that may be selected to complete a purchase.

32. The computer program product of claim 31, wherein the program code implementing the method further comprises:
receiving product scan data and comparing the product scan data against one of offer data and coupon data in a database.

33. The computer program product of claim 32, wherein the program code implementing the method further comprises:
sending any matches of product scan data to offer data or coupon data over the computer communications network.

34. The computer program product of claim 31, wherein the program code implementing the method further comprises:
generating a message that lists one or more preferred payment options based on operator preferences listed in a client profile.

35. The computer program product of claim 34, wherein the one or more preferred payment options comprises account information corresponding to at least one of a credit card account, a debit card account, a checking account, a savings account, and a stored value account.

36. The computer program product of claim 31, wherein the program code implementing the method further comprises:
processing a request to pay for a purchase from a non-traditional payment method comprising one of an on-line financial institution and a mobile phone service carrier.

37. The computer program product of claim 31, wherein the program code implementing the method further comprises:
generating an offer for a private label credit card.

38. The computer program product of claim 31, wherein the program code implementing the method further comprises:
displaying one or more preferred payment options on a display device of the personal computing device.

39. The computer program product of claim 31, wherein the program code implementing the method further comprises:
generating one or more offers based on one or more products being purchased and storing the offers in a database.

40. The computer program product of claim 31, wherein merchant identifier is part of a machine-readable tag, the machine-readable tag being attached to a physical object or being projected in an image on a display device.
